(19) United States
(12) Patent Application Publication
(10) Pub. No.: US 2021/0272133 A1
(43) Pub. Date: Sep. 2, 2021

(54) Illegitimate Trade Detection for Electrical Energy Markets

(71) Applicant: Mitsubishi Electric Research Laboratories, Inc., Cambridge, MA (US)

(72) Inventor: Hongbo Sun, Lexington, MA (US)

(73) Assignee: Mitsubishi Electric Research Laboratories, Inc., Cambridge, MA (US)

(21) Appl. No.: 16/800,503

(22) Filed: Feb. 25, 2020

(51) Int. Cl. G06Q 30/00; G06Q 50/06; G06Q 40/04; G05B 13/02; G06N 3/04; G06N 3/08; H02J 3/38; H02J 3/00

(52) U.S. Cl. CPC G06Q 30/0185; G06Q 50/06; G06Q 40/04; G05B 13/027; H02J 2203/20; G06N 3/08; H02J 3/381; H02J 3/008; G06N 3/04

(57) ABSTRACT

Systems and methods to control power generated by power producers or control power consumed by power consumers, for a period of time. The method receives electronically current (EC) data that includes trade sets for a given trader obtained from cleared energy data and bided energy data, over a number of respective time increments, within a predetermined period of time. Determining a set of feature attributes for each trade set. Using a trained anomaly trade module with the determined sets of feature attributes, to detect each trade set as either a true trade or a type of anomaly trade from multiple anomaly trades. Generating a control command based on the detected type of anomaly trade. Outputting the control command to a controller associated, wherein the control command controls the power generated or controls the power consumed, for a period of time, based upon the detected type of anomaly trade.

### FIELD

The present disclosure relates to electric power systems, and more particularly to illegitimate trade detection across electrical energy markets.

### BACKGROUND

Electricity energy trading markets are designed based on rules and incentives so a workably competitive market can be achieved by an expected legitimate trading behaviour by market participants. For example, in the United States (US) the electricity energy trading markets framework is based on the model of bid-based approach where market participants bid amounts of energy that can be produced and/or amounts of energy that can be consumed for a period of time. The US organized electricity markets are run by Regional Transmission Organizations (RTOs) or Independent System Operators (ISOs) which are built around this model, and have a two-settlement structure with day-ahead and real-time coordinated markets. As noted above, the commodity traded in each market is the quantity of power, in MWh, produced and consumed in real-time at a given location on the transmission network. The day-ahead market on the day before the actual power is dispatched, creates a financial obligation to buy or sell power to be delivered in real-time. In contrast, the real-time market is a physical market where actual supply and demand of electricity are balanced continuously over the delivery day. In both auctions, the result is market clearing with locational marginal prices that, under competitive market conditions, reflect the short-run marginal cost of serving one incremental megawatt of load at each node, i.e. power supplying point. Sales and purchases cleared at the day-ahead price that are not converted into physical positions must be bought or sold back at the real-time price.

Because of the lack of ways for storing the energy economically, the existence of capacity and transmission constraints, and the small short-run price elasticity of demand, real-time physical markets are vulnerable to price manipulation. For example, power generators, i.e. market participants, can exercise supplier market power by not bidding all of their available energy capacity into the market, in essence, these power generators withhold some of their energy capacity into the market, i.e. termed “physical withholding”. Or, the power generators can by raising offer prices above the marginal cost of production, can cause the energy prices to increase, i.e. termed “economic withholding”. However, although there are many instituted rules in place, along with many efforts by the RTO's, the ISO's and others to monitor the market players to prevent this type of generator manipulation, manipulation is still occurs.

As evidence of this generator manipulation, the Federal Energy Regulatory Commission (FERC) has raised policy concerns by enforcement actions that focuses on price manipulation involving forward electricity markets and related financial positions. For example, market participants may act against their economic interest in the day-ahead market to artificially move prices and benefit related positions in another market. FERC brought several actions against market participants that involved uneconomic (i.e., unprofitable) virtual transactions and alleged manipulation of day-ahead prices to benefit related financial transmission rights (FTRs). Cross-product manipulation cases are being litigated or resulted in multi-million dollar settlements where the accused market participants may not admit to the behavior alleged. Constellation Energy was investigated by FERC in 2012 allegedly for electricity market cross-product manipulation (see 138 FERC 61,168). A settlement resulted in $135 million in civil penalties and $110 million in disgorged profits, but with no agreement on the merits of FERC's claim.

Presently, an immediate challenge facing the electrical energy markets is the lack of such a cross-product manipulation model for these electricity markets. Further, there is the impending need for market monitoring and enforcement activities that can distinguish between manipulative, i.e. illegitimate trading, and efficient transactions, i.e. legitimate trading. Yet, the theoretical foundations of day-ahead electricity manipulation are neither obvious nor well developed.

Accordingly, there is a need for a cross-product manipulation model for these electricity markets. Further, there is also a need for market monitoring and enforcement activities that can distinguish between manipulative, i.e. illegitimate trading, and efficient transactions, i.e. legitimate trading, among other aspects.

### SUMMARY

The present disclosure relates to electric power systems, and more particularly to illegitimate trade detection across electrical energy markets.

Some embodiments are based on recognition of how to identify and determine market participant creative manipulative schemes, patterns and manipulative behaviors, to properly protect the efficiency and integrity of the electrical energy markets from market manipulation. Through experimentation several realizations included discovering a set of feature attributes for each trade set of a given trader, i.e. a market player transaction in the Day Ahead Energy Market that corresponds to a transaction in the Real-time Energy Market, that can be used to identify manipulation behavior by a given trader across the two markets. In order to determine the set of feature attributes for each trade set of a given trader, current transactional data across the two markets need to be gathered and saved into a memory. Upon gathering the current transaction data or electronic current (EC) data, then each feature attribute of the set of feature attributes can be determined using stored functions. Wherein each feature attribute includes an associated function in order to determine that feature attribute. For example, some of the feature attributes in the set of feature attributes can include, by non-limiting example, one or a combination of a peak shortage value, a valley excess value, a capacity matching value, an up-ramping shortage value, a down-ramping shortage value, a ramping matching value, a cross-market correlation value by comparing the cleared day-ahead data and executed real-time bid data, or environmental impact value. Once the set of feature attributes has been determined using each respective function for each feature attribute, the determined set of feature attributes can be used to determine true trades or legitimate trades, or types of anomaly trades, i.e. types of illegitimate trades, types of manipulation behavior, by a given trader. Under circumstances where no manipulation was identified or detected, i.e. the true trades or legitimate trades, then the true trades can be stored in memory.

Another realization was the developing of a trained anomaly trade module that uses the determined set of feature attributes, to detect each trade set as either a true trade, i.e. legitimate trade having no manipulation, or a type of anomaly trade i.e. a particular type of illegitimate trade or a particular type of manipulation behavior, from multiple types of anomaly trades. For example, some types of anomaly trades can include, by non-limiting example, anomaly peak, anomaly valley, anomaly power usage, anomaly up-ramp, anomaly down-ramp, anomaly ramp usage, and cross-market inconsistence.

The trained anomaly trade module can include a multiple layer feedforward neural network to represent the relationship between the trade legitimacy status and the trade feature attributes. The trade legitimacy status can answer the questions about if the trade is legitimate and what type of illegitimate trade can be identified when the trade is determined as illegitimate. The parameters of the neural network are determined through supervised learning using a set of trade samples with assigned legitimacy status labels. The trade samples include three different subsets of samples, the first subset is the set of legitimate trade samples retrieved from historical data of day-ahead and real-time markets, the second subset is the set of simulated typical illegitimate trade profiles pre-defined for each illegitimate trading type according to market regulation rules, and the third set is the set of generated illegitimate trade feature samples that created based on legitimate samples using a genetic algorithm based negative selection procedure, and labeled with specific illegitimate type by comparing with trade features of pre-defined typical illegitimate samples. The trained anomaly trade module then can be used to monitor if an oncoming real-time biding is legitimate, and what type of illegitimate trade type it should be if it is an illegitimate trading behavior. It can also be used to determine or prove the legitimacy of a historical bid, i.e. a cleared bid.

When, a type of anomaly trade, i.e. illegitimate trade is detected, then a control command can be generated by a processor or computer based on the detected type of anomaly trade and outputted to a (market or power system) controller associated with an operator to implement the control command. An example of a control command could be notifying a Regional Transmission Organizations (RTOs) operator or an Independent Systems Operator (ISO), or the like. For example, each detected type of anomaly trade can correspond to one or more predetermined action(s) related to one or more predetermined control command(s) to be implemented. Wherein, a table of types of anomaly trades with their associated actions with control commands can be generated, and stored in the memory. Also, the stored table of the types of anomaly trades can later be updated after each detection of a type of anomaly trade or a new type of anomaly via the trained anomaly trade module. Upon the detection of a type of anomaly, the detected type of anomaly can be used to update a most recent updated trained anomaly trade module. Conversely, upon no detection of manipulation, i.e. upon the detection of true trades or legitimate trades, then the detected true trades can be used to update a most recent updated trained anomaly trade module. The updating of trained modules at a reasonable frequency is necessary for catching up the evolution of power system infrastructure, market participant configuration, and market regulation rules in a timely manner.

Upon the detection of a type of anomaly, the processor or computer can access the table of predetermined types of anomalies from the memory, and generate at least one predetermined control command associated with the detected type of anomaly. For example, if the type of anomaly is described as abnormal peak, and upon accessing the table of predetermined types of anomalies from the memory, the processor or computer generates the predetermined control command associated with the detected type of anomaly. The control command may include raising power generation levels or energizing more generation units if the market participant is a power producer, or lowering power consumption levels or de-energizing more appliances if the market participant is a power consumer. By non-limiting example, the control command can be sent to a controller associated with an operator via the processor or computer, wherein the operator reviews the control command and implements the control command via the controller. Wherein one or more actions of the control command can include controlling an amount of power generated by one or more generators or controlling an amount of power consumed by one or more power consumers, for a period of time, for at least one market participant of the electric energy markets.

However, to better understand market participant manipulation, one needs to grasp a general understanding of the electrical energy market goals. For example, at least one goal of power grid is maintaining a balance between electricity production and electricity consumption. The trading of energy production and consumption are achieved through the electrical energy markets, such as day ahead market and real time market. The energy trading activities between two markets at different time scales can be deviated to some extent, but inherent energy usage patterns should closely match each other to avoid a significant operation cost increase in the power grid, and unfair economy benefits to power market players.

The electrical energy markets collect a large amount of data from market participants/players at different time scales, but there is a lack of legitimacy information about those trading activities that causes problems. The reason legitimacy information is important to the energy market players, is that illegitimate trading can occur, such that these illegitimate trading events can be quite dramatic and quite often in a negative sense. For example, legitimate market participation increases overall market efficiency, whereas manipulative behavior distorts the electrical energy markets and reduces efficiency. At least one experimental example of a manipulative behavior by a market participant could be the placement of “virtual” load or supply to enhance the value of financial transmission rights. Wherein, an intentional uneconomic trading of virtual bids by the market player, i.e. “the manipulation behavior”, causes a divergence of day-ahead and real-time nodal prices, and thus creates market distortions and inefficiencies, (i.e. nodal pricing is a method of determining prices in which market clearing prices are calculated for a number of locations on the transmission grid, called nodes, each node represents a physical location on the transmission system where energy is injected by generators or withdrawn by loads). This sort of manipulative behavior can be termed as benefited trading in related markets, wherein market players make uneconomic transactions.

Uneconomic transactions are those which, simply, are unprofitable on a stand-alone, short-term basis. The necessary corollary to such transactions is the presence of transactions in a separate market that will benefit from the uneconomic transaction. These markets are frequently separated either in time, or by the physical and financial, or by geographical location, i.e. the day ahead market and the real time market. In order to identify these uneconomic transactions, links need to identified to gather such evidence between the market participant's actions in the day ahead market which correspond to actions in the real time market, in order for evidence of market manipulation to be identified/determined. These uneconomic transactions (or other actions) by market players have the effect of moving profits from the day-ahead market to the real-time market, or vice versa, which can significantly create market distortions and inefficiencies in the marketplace. At least one aspect learned from this experiment, is when uneconomic transactions start to resemble market manipulation where such trades are made repeatedly, and often at high volumes, when economic principles suggest that rational actors ought to forestall future trades.

FERC defines market manipulation broadly to include: (a) use of any device, scheme or artifice to defraud; (b) making untrue statements of a material fact or to omit to state a material fact necessary in order to make the statements made, in the light of the circumstances under which they were made, not misleading; or acts, practices or courses of business that operate or would operate as a fraud or deceit upon any entity. The illegitimate trading addressed in this disclosure refers to the market manipulation occurring across two electricity markets with different bidding time intervals, that is a trader try to manipulate market power such that its cleared bids with longer biding intervals deviating from executed or executing bids at shorter bidding interval to significant extent but lacking of plausible excuses (such as equipment failure, unanticipated weather conditions or events).

The illegitimate trading poses serious threats to the stable operation of power systems. Power grid expects its operation scheduling for longer intervals is closely matching its actual dispatching for real-time or shorter intervals which has been supported by legitimate trading. If there are significant deviations from reasonable mismatches between scheduling and dispatching as caused by illegitimate trading, power grid either has to purchase more online reserves to mitigate the mismatches, or scarify the service quality in term of voltage levels or frequency. If the mismatches result in more frequent ramping up and down for generation units or power storage adjustment, the lifetime of associated equipment might be reduced significantly.

Some of the many challenges of the present disclosure included trying to define what is a representative illegitimate trade. Because the boundary between legitimate and illegitimate behavior is often not precise, and that legitimate trading behavior keep evolving as well. Some embodiments of the present disclosure provide methods for identifying and detecting this type of market participant manipulation behavior based on a realization that illegitimate trade can be a pattern in the trade activities that does not conform to the expected legitimate trading behavior, and the legitimate trading behavior can be learned from historical trading profiles and its evolving can be captured through updating with latest trading profiles at a regular pace.

During experimentation, some experimental methods were tested for detecting illegitimate trade activities across electricity energy markets with different trading intervals. These experimental efforts mainly focused on market prediction and dominance analysis, such as predicting an action of a market player, a state of a power transfer path, and a market price on a basis of a sales order information prediction value and a prediction value for the power transfer path state. However, what was later discovered from these experimental methods is that the prediction for player behavior, market physical restriction and the analysis of market dominance could not provide meaningful indication to whether the bids or offers given by a market participant is legitimate, therefore those methods could not be used for detecting the illegitimate trades across two markets with different time intervals.

As noted above, the disclosed detection systems and methods detect the illegitimate trading activities across day-ahead energy market and real-time energy market using the determined set of feature attributes with the trained anomaly trade module, to detect each trade set as either a true trade or a type of anomaly trade from multiple anomaly trades.

According to an embodiment of the disclosure, a system for controlling an amount of power generated by one or more generators or controlling an amount of power consumed by one or more power consumers, for a period of time. The system including a computer including memory that stores data. The data includes trained modules, historical data, and computer-readable instructions that, when executed, cause the computer to perform the steps of receiving data including electronically current (EC) data. The EC data includes trade sets for a given trader obtained from cleared energy data and bided energy data, over a number of respective time increments, within a predetermined period of time. Wherein each trade set includes a longer time interval and a corresponding set of shorter time intervals. Determine a set of feature attributes for each trade set of the trade sets with the received current data. Wherein the set of features attributes includes one or a combination of, a peak shortage value, a valley excess value, a capacity matching value, an up-ramping shortage value, a down-ramping shortage value, a ramping matching value, a correlation value by comparing the cleared day-ahead data and real-time execution data, or an environmental impact value. Use a trained anomaly trade module with the determined sets of feature attributes, to detect each trade set as either a true trade or a type of anomaly trade from multiple anomaly trades, if the true trade is detected, then the detected true trade is stored in the memory. Generate a control command based on the detected type of anomaly trade from the multiple anomaly trades. Output the control command to a controller associated with an operator. Wherein the control command controls the amount of power generated by the one or more power producers or controls the amount of power consumed by the one or more power consumers, for a period of time, based upon the detected type of anomaly trade.

According to an embodiment of the disclosure, a method for controlling an amount of power generated by one or more generators or controlling an amount of power consumed by one or more power consumers, for a period of time. The method including receiving data including electronically current (EC) data. The EC data includes trade sets for a given trader obtained from cleared energy data and bided energy data, over a number of respective time increments, within a predetermined period of time. Wherein each trade set includes a longer time interval and a corresponding set of shorter time intervals. Determining a set of feature attributes for each trade set of the trade sets with the received EC data. Wherein the set of features attributes includes one or a combination of, a peak shortage value, a valley excess value, a capacity matching value, an up-ramping shortage value, a down-ramping shortage value, a ramping matching value, a cross-market correlation value by comparing the cleared day-ahead data and real-time execution data, or an environmental impact value. Using a trained anomaly trade module with the determined sets of feature attributes, to detect each trade set as either a true trade or a type of anomaly trade from multiple anomaly trades, if the true trade is detected, then the detected true trade is stored in a memory. Generating a control command based on the detected type of anomaly trade from the multiple anomaly trades. Outputting the control command to a controller associated with an operator. Wherein the control command controls the amount of power generated by the one or more power producers or controls the amount of power consumed by the one or more power consumers, for a period of time, based upon the detected type of anomaly trade. Wherein the steps of the method are implemented using a processor connected to the memory.

According to an embodiment of the disclosure, a non-transitory computer readable storage medium embodied thereon a program executable by a computer for performing a method. The method for controlling an amount of power generated by one or more generators or controlling an amount of power consumed by one or more power consumers, for a period of time. The method including receiving data including electronically current (EC) data. The EC data includes trade sets for a given trader obtained from cleared energy data and bided energy data, over a number of respective time increments, within a predetermined period of time. Wherein each trade set includes a longer time interval and a corresponding set of shorter time intervals. Determining a set of feature attributes for each trade set of the trade sets with the received EC data. Wherein the set of features attributes includes one or a combination of, a peak shortage value, a valley excess value, a capacity matching value, an up-ramping shortage value, a down-ramping shortage value, a ramping matching value, a cross-market correlation value by comparing the cleared day-ahead data and real-time execution data, or an environmental impact value. Using a trained anomaly trade module with the determined sets of feature attributes, to detect each trade set as either a true trade or a type of anomaly trade from multiple anomaly trades, if the true trade is detected, then the detected true trade is stored in a memory. Generating a control command based on the detected type of anomaly trade from the multiple anomaly trades. Outputting the control command to a controller associated with an operator. Wherein the control command controls the amount of power generated by the one or more power producers or controls the amount of power consumed by the one or more power consumers, for a period of time, based upon the detected type of anomaly trade. Wherein the steps of the method are implemented using a processor connected to the memory.

### BRIEF DESCRIPTION OF THE DRAWINGS

The present disclosure is further described in the detailed description which follows, in reference to the noted plurality of drawings by way of non-limiting examples of exemplary embodiments of the present disclosure, in which like reference numerals represent similar parts throughout the several views of the drawings. The drawings shown are not necessarily to scale, with emphasis instead generally being placed upon illustrating the principles of the presently disclosed embodiments.

FIG. 1A a schematic block diagram of some steps for controlling an amount of power generated by one or more generators or controlling an amount of power consumed by one or more power consumers, for a period of time, according to some embodiments of the present disclosure;

FIG. 1B is a schematic illustrating components and steps of controlling an amount of power generated by one or more generators or controlling an amount of power consumed by one or more power consumers, for a period of time, according to some embodiments of the present disclosure;

FIG. 1C is a schematic illustrating a power system regulated by an independent system operator (ISO) that includes power producers that generate power and power consumers that consume power, according to some embodiments of the present disclosure;

FIG. 2A and FIG. 2B are block diagrams illustrating some method steps to detect illegitimate trading activities across day-ahead energy market and real-time energy market including a supervised learning stage (FIG. 2A) and a real-time detection stage (FIG. 2B), according to some embodiments of the present disclosure;

FIG. 3A and FIG. 3B are graphs illustrating legitimate trades across two energy markets including the cleared day-ahead hourly bids (FIG. 3A) and real-time bids for each five (5) minutes (FIG. 3B) for two consecutive days, according to some embodiments of the present disclosure;

FIG. 4A and FIG. 4B are graphs illustrating possible illegitimate trades at peak hours including the cleared day-ahead hourly bids (FIG. 4A) and real-time bids for each five (5) minutes (FIG. 4B) for two consecutive days, according to some embodiments of the present disclosure;

FIG. 5A and FIG. 5B are graphs illustrating possible illegitimate trades at valley hours including the cleared day-ahead hourly bids (FIG. 5A) and real-time bids for each five (5) minutes (FIG. 5B) for two consecutive days, according to some embodiments of the present disclosure;

FIG. 6A and FIG. 6B are schematics illustrating a genetic algorithms-based negative selection procedure used to generate illegitimate trade feature samples, and label each sample with a specific label of illegitimate trade type defined by pre-defined typical illegitimate trade samples, according to some embodiments of the present disclosure;

FIG. 7 is a schematic illustrating configuration of a multiple-layer feedforward neural networks (FNN) used for modeling illegitimate trade classification functions, according to some embodiments of the present disclosure;

FIG. 8A and FIG. 8B are graphs illustrating the estimation results for using a multiple-layer feedforward neural network to estimate the legitimacy status of trading activities against sets of training samples and testing samples, according to some embodiments of the present disclosure; and

FIG. 9 is a block diagram of illustrating the method of FIG. 1A, that can be implemented using an alternate electricity energy market controller, according to embodiments of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The present disclosure present disclosure relates to electric power systems, and more particularly to illegitimate trade detection across electrical energy markets.

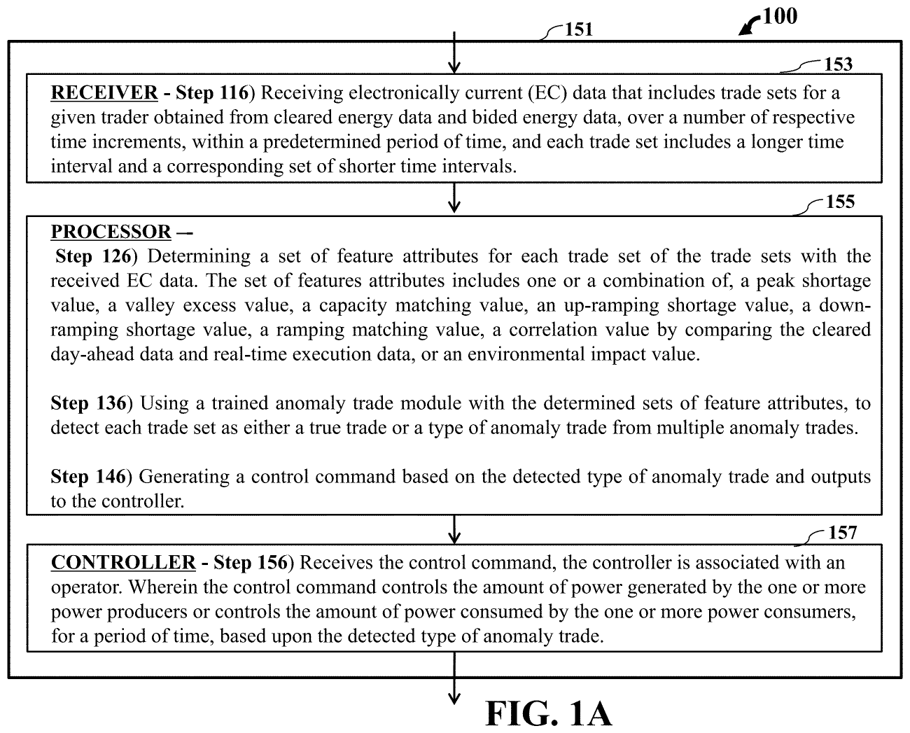

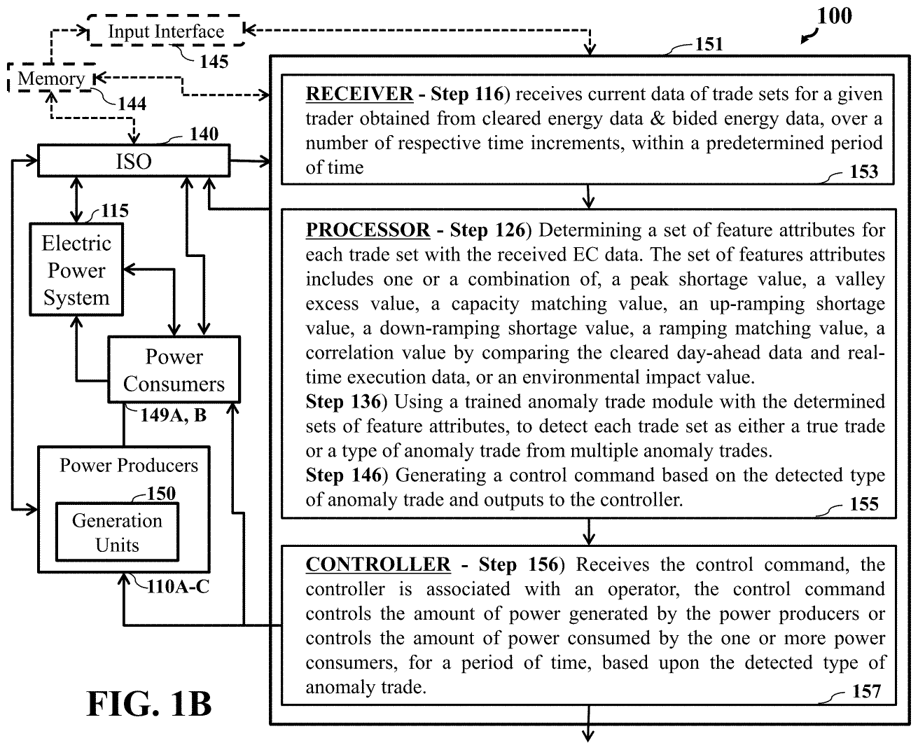

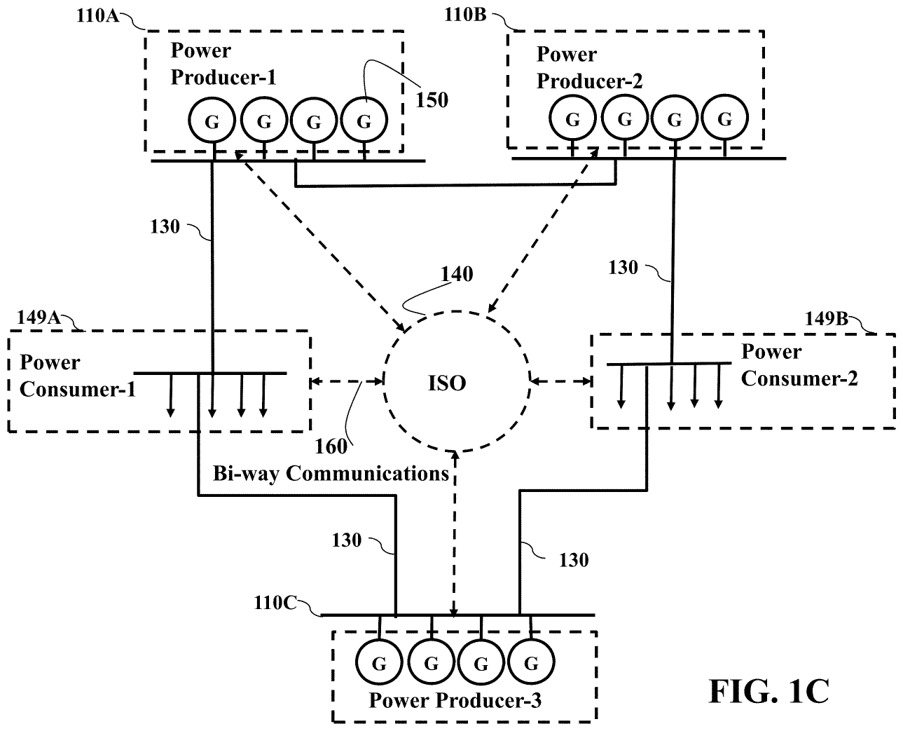

FIG. 1A a schematic block diagram 100 of some steps of a method 151 for controlling an amount of power generated by one or more generators or controlling an amount of power consumed by one or more power consumers, for a period of time, according to some embodiments of the present disclosure.

Step 116 of FIG. 1A, includes a receiver 153 for receiving data including electronically current (EC) data. The EC data includes trade sets for a given trader obtained from cleared energy data and bided energy data, over a number of respective time increments, within a predetermined period of time. Wherein each trade set includes a longer time interval and a corresponding set of shorter time intervals.

Step 126 of FIG. 1A, includes a processor or computer 155 in communication with the receiver 153, that is configured to determine a set of feature attributes for each trade set of the trade sets with the received EC data. Wherein the set of features attributes includes one or a combination of, a peak shortage value, a valley excess value, a capacity matching value, an up-ramping shortage value, a down-ramping shortage value, a ramping matching value, a cross-market correlation value by comparing the cleared day-ahead data and real-time execution data, or an environmental impact value.

Step 136 of FIG. 1A, is processed using the processor 155 to use a trained anomaly trade module with the determined sets of feature attributes, to detect each trade set as either a true trade or a type of anomaly trade from multiple anomaly trades, if the true trade is detected, then the detected true trade is stored in a memory. It is contemplated that multiple processors may be used depending upon the application.

Step 146 of FIG. 1A, is processed using the processor 155 to generate a control command based on the detected type of anomaly trade from the multiple anomaly trades and outputs to the controller 157.

Step 156 of FIG. 1A, includes receiving the control command by the controller 157, such that the controller 157 associated with an operator. Wherein the control command controls the amount of power generated by one or more generators or controls the amount power consumed by the one or more power consumers, for a period of time, based upon the detected type of anomaly trade. Wherein the steps of the method are implemented using a processor connected to the memory. Again, it is contemplated that multiple controllers can be used depending upon the application, along that the multiple controllers can be differently located.

FIG. 1B is a schematic illustrating components and steps of controlling an amount of power generated by one or more generators or controlling an amount of power consumed by one or more power consumers, for a period of time, according to some embodiments of the present disclosure.

The generation units 150 of a power producer 110A-C generates and provides electricity to the electric power system 115 that can be operated by an independent system operator (ISO) 140. Control commands can be generated by the processor 155 to control an amount of power generated by the generators 150, wherein the control commands are outputted to the controller 157, the controller 157 received the control commands from the process 155. Such that the controller 157 can be associated with the ISO 140, wherein the ISO 140 can review the control commands and implement the control commands with the controller 157 associated with the ISO 140 for a period of time.

The power consumers 149A, B consumes power from the electric power system 115 that can be operated by the independent system operator (ISO) 140. Control commands can be generated by the processor 155 to control an amount of power consumed by the power consumers 149A, B, wherein the control commands are outputted to the controller 157, the controller 157 received the control commands from the process 155. Such that the controller 157 can be associated with the ISO 140, wherein the ISO 140 can review the control commands and implement the control commands with the controller 157 associated with the ISO 140 for a period of time.

Still referring to FIG. 1B, the receiver 153 can also receive historical data or the historical data can already be stored in the memory 144. The historical data can include past transaction data from a given trader across the electrical energy markets for past periods of time. For example, the historical data includes past trade sets from a given trade that can be obtained from past cleared energy data and past bided energy data, over a number of respective past time increments, within a predetermined past period of time, wherein each past trade set includes a longer time interval and a corresponding set of shorter time intervals. The longer time interval is a past cleared energy bid for a past day-ahead bidding interval in a past day-ahead energy market, and the historical data shorter time interval is a corresponding executed past real-time bid associated with the past cleared energy bid, such that the executed past real-time bid is for a past real-time bidding interval in a past real-time energy market. Further, the historical data longer time interval is at a different time interval than the historical data shorter time interval. Further still, the historical data includes past environmental impact value data, that is associated with past weather, past equipment forced or planned outages, past holiday's, past special events or other like past data causing an effect to past trading activities.

The processor 155 then, in communication with the receiver 153, determine a set of feature attributes for each trade set of the trade sets with the received EC data. Wherein the set of features attributes includes one or a combination of, a peak shortage value, a valley excess value, a capacity matching value, an up-ramping shortage value, a down-ramping shortage value, a ramping matching value, a cross-market correlation value by comparing the cleared day-ahead data and real-time execution data, or an environmental impact value, according to step 126 of FIG. 1B. Then, the processor 155 uses the trained anomaly trade module with the determined sets of feature attributes, to detect each trade set as either a true trade or a type of anomaly trade from multiple anomaly trades, if the true trade is detected, then the detected true trade is stored in a memory, according to step 136 of FIG. 1B. Wherein the processor 155 generates the control command based on the detected type of anomaly trade from the multiple anomaly trades and outputs to the controller 157, according to step 146 of FIG. 1B. Such that, the controller 157 receives the control command, where the controller is associated with an operator 140. The control command controls the amount of power generated by the one or more generators 110A, B, C or controls the amount power consumed by the one or more power consumers 149A, B, for a period of time, based upon the detected type of anomaly trade. It is contemplated the receiver, processor and controller could be a single computer system or multiple computer systems located at different locations depending on the specific application(s).

FIG. 1C is a schematic illustrating an electric power system regulated by an independent system operator (ISO), according to some embodiments of the present disclosure. In particular, FIG. 1C shows an electric power system 115 under an electricity market environment. The electric power system can include a set of power plants that produce powers for the system, called power producers, 110A, 110B and 110C. Each power producer 110A, 110B and 110C may have multiple generation units, or called generators, 150. The electric power system 115 can also include a set of end-users, called power consumers, 149A, 149B to consume the powers provided by the power producers 110A, 110B and 110C through the network connected by transmission lines, 130. An independent system operator (ISO), 140 is responsible for the coordination between producers and consumers to maintain stable operation of the electric power system 115. A communication network may be used for exchanging information between the ISO and the producers, or the consumers through communication links, 160. In FIG. 1C, as an example, there are 3 power producers 110A, 110B and 110C, 2 power consumers 149A, 149B, and 5 transmission lines 130. Each producer 110A, 110B and 110C can have 4 generators 150. The ISO manages the trading processes of power producers and power consumers, monitors the health of associated electricity markets, and control the generations of power producers and the consumptions of power consumers.

Still referring to FIG. 1C, the ISO can monitor the trading activities of market participants by comparing their current activities with corresponding historical trading and environmental data. The historical data can include historical bids or offers, historical locational marginal prices, and historical cleared bids and offers. The historical environmental data can include historical weather information, historical generator or appliance capacities and maintenance schedules, and special event information. The ISO can learn the anomaly trade module for a given participant through a set of historical data set for a period of days for the participant, wherein each data set corresponding to a specific day includes historical bids or offers, historical cleared amounts and prices, historical temperatures, and historical equipment conditions.

Through carefully surveillance of the health of multiple electricity markets, the ISO may take proactive actions to prevent impending illegitimate trades occurring, such as executing generation and load re-dispatch when a potential illegitimate trade is identified, or take corrective actions to mitigate the impacts of occurred illegitimate trades such as exerting economical punishment to the trader and constraining future trade rights when a past illegitimate trade is verdict.

The present disclosure discloses systems and methods for controlling an amount of power generated by one or more generators and consumed by one or more consumers which physically connects to an electric power system through transmission lines. Wherein the electric power system is operated by an ISO, and have at least one more power producer producing powers and at least one power consumer consuming powers. Wherein the power producer and the power consumer communicate with the ISO through bi-way communication links.

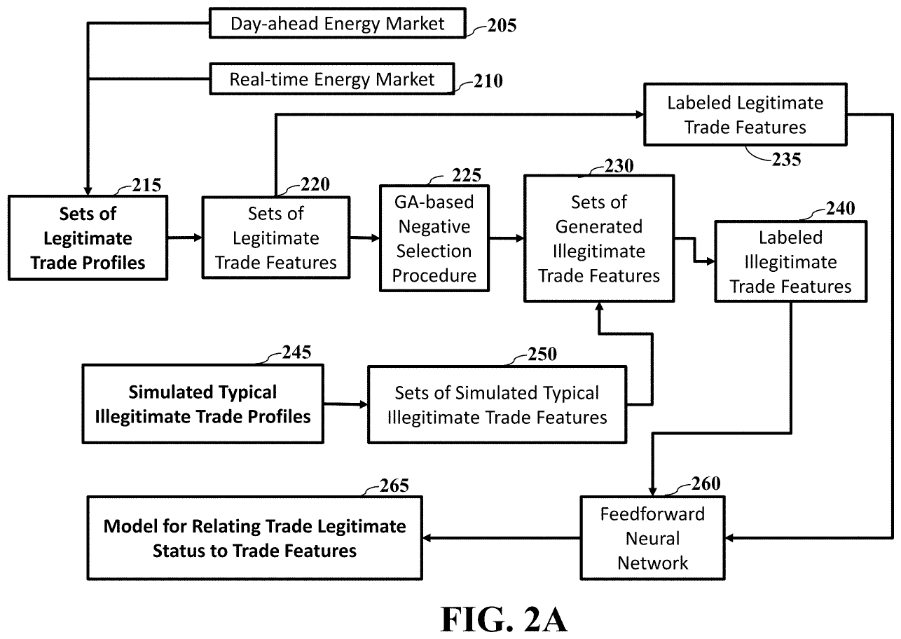

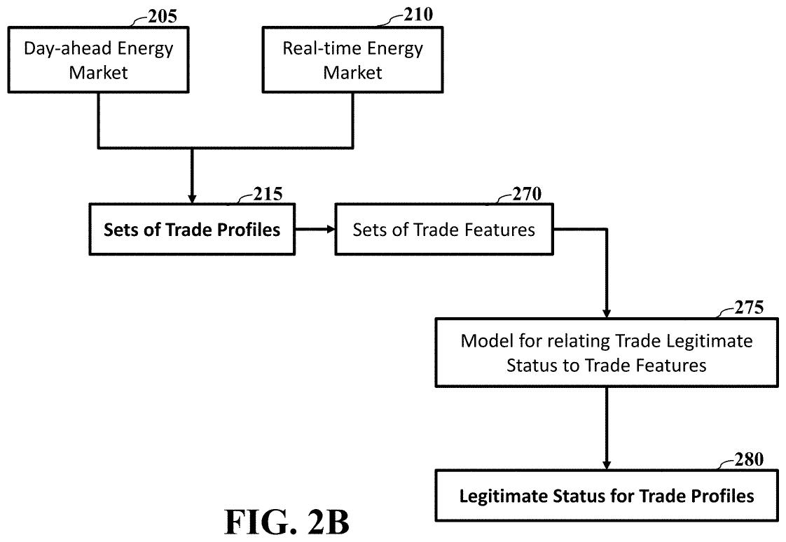

FIG. 2A and FIG. 2B illustrate the procedure for implementing the detection of illegitimate trading activities across day-ahead energy market and real-time energy market, according to the embodiments of this disclosure. It includes two stages, a supervised learning stage as shown in FIG. 2A, and a real-time detection stage as shown in FIG. 2B.

The goal of the supervised learning stage is building up a mathematical model that can be used to label a given trading activities as legitimate, or illegitimate with specific types based on a set of feature attributes extracted from corresponding trade profiles of day-ahead energy market 205 and real-time energy market 210.

Due to lack of verdict illegitimate trading activities, only the legitimate trade profiles 215 are available for trading legitimacy model learning. For each data set of normal trading, i.e. legitimate trading 215, we have determining a set of feature attributes to represent its legitimacy status 220, such as peak shortage attribute, valley excess attribute, capacity matching attribute, up-ramping shortage attribute, down-ramping shortage attribute, ramping matching attribute, day-ahead and real-time correlation attribute, and environment impact attribute. Then, based on the negative selection procedure and the genetic algorithm 225, generating a set of illegitimate trading feature samples 230 solely based on legitimate trade samples 220.

Each data set of normal trading includes a set of cleared day-ahead bids and corresponding executed real-time bids or real-time bids to be executed for a given length of time period in which the associated trading activities can be regarded as legitimate.

Illegitimate trading feature samples are defined as sets of trade feature samples that represent the characteristics of illegitimate trading activities. Wherein the illegitimate trading feature samples are generated by finding sets of trade feature samples that are within feasible domain of trade feature space but have not taken by samples of legitimate trade features. Wherein samples of legitimate trade features are determined by computing associated trade features of actual legitimate trade profiles. Wherein legitimate trade profiles are obtained from bids of day-ahead market and real-time market.

Different illegitimate trading activities may reveal different patterns. Therefore, the illegitimate trading can be classified into different types, and different type trading may have different impacts to the power system. According to its impacts on power trades across markets, some typical illegitimate trade types can be given and described as follows:
a. Anomaly peak (peak hour manipulation)—is defined as that during the period of system/or other peak hours that a power producer significantly reduces its real-time average power production than its cleared day-ahead selling bids, or a power consumer significantly increases its real-time average power consumption than its cleared day-ahead purchasing bids without plausible reasons. Such activities might cause system short of up-reserve capacities and deteriorate system frequency or voltages.
b. Anomaly valley (valley hour manipulation)—is defined as that during the period of system or other valley hours that a power producer significantly increases its real-time average power production than its cleared day-ahead selling bids, or a power consumer significantly decreases its real-time average power consumption than its cleared day-ahead purchasing bids without plausible reasons. Such activities might cause system short of down-reserve capacities and deteriorate system frequency or voltages.
c. Anomaly power usage is defined as that during a given length of time window that there are unreasonable significant differences between executed real-time bids and cleared day-ahead bids for a power producer or a power consumer. Except occurring at peak or valley hours, such activities mainly impact the economical operation of power system, and associated fuel scheduling.
d. Anomaly up-ramp—is defined as that during a given length of time window for power ramping-up that there are unreasonable significant differences on power ramping-up rates between executed real-time bids and cleared day-ahead bids. Such activities might cause system short of ramping-up reserves and deteriorate system power quality.
e. Anomaly down-ramp—is defined as that during a given length of time window for power ramping-down that there are unreasonable significant differences on power ramping-down rates between executed real-time bids and cleared day-ahead bids. Such activities might cause system short of ramping-down reserves and deteriorate system power quality.
f. Anomaly ramp usage—is defined as that during a given length of time window that there are unreasonable significant differences on power variation rates between executed real-time bids and cleared day-ahead bids. Such activities might cause system short of ramping reserves and deteriorate system power quality.
g. Cross-market Inconsistence—is defined as that during a given day-ahead cycle that there are significant differences on the magnitudes and rates of power variations between executed real-time bids and cleared day-ahead bids. Such activities might cause system short of reserves and deteriorate system operation economy and power quality.

In order to assign an appropriate label for illegitimate trade type 240 for each generated illegitimate sample. A set of typical day-ahead and real-time trading profiles 245 are first created through simulating trading activities for each typical illegitimate trade type, and then determined its corresponding set of trade feature attributes 250 accordingly. These simulated typical illegitimate samples 250 are then used to determine a specific label for each generated illegitimate sample based on the distance between the simulated typical illegitimate samples and the generated illegitimate samples, 240. After that, a multiple layer feedforward neural network 260 is configured to model 265 the relationship between trade features and trade legitimacy status. The parameters of the neural network are determined through training with all available samples, including existing legitimate samples, simulated typical illegitimate samples, and labeled generated illegitimate samples. The neural network takes trade feature attributes of samples as its inputs, and trade legitimacy statuses of samples as its output.

As shown in FIG. 2B, the goal of real-time detection stage is determining the legitimacy status 280 for an impending trade based on the determined model 275 for relating trade legitimacy status to trade features 270 in the first step, when the associated online trade profiles 215 are retrieved from day-ahead energy market 205 and real-time energy market 210.

The illegitimate trade type detection disclosed in this disclosure is based on the comparison of trading profiles between two markets with different time intervals. If only the energy deviation from the market with longer time interval is traded at the market with shorter time interval, then the execution energy for the market with shorter time interval can be set as the sum of two markets with different time intervals. For example, the real-time execution trade profile can be determined as the summation of real-time trade profiles and day-ahead trade profiles within the same time period, when the real-time market only trade real-time energy deviation from the day-ahead market.

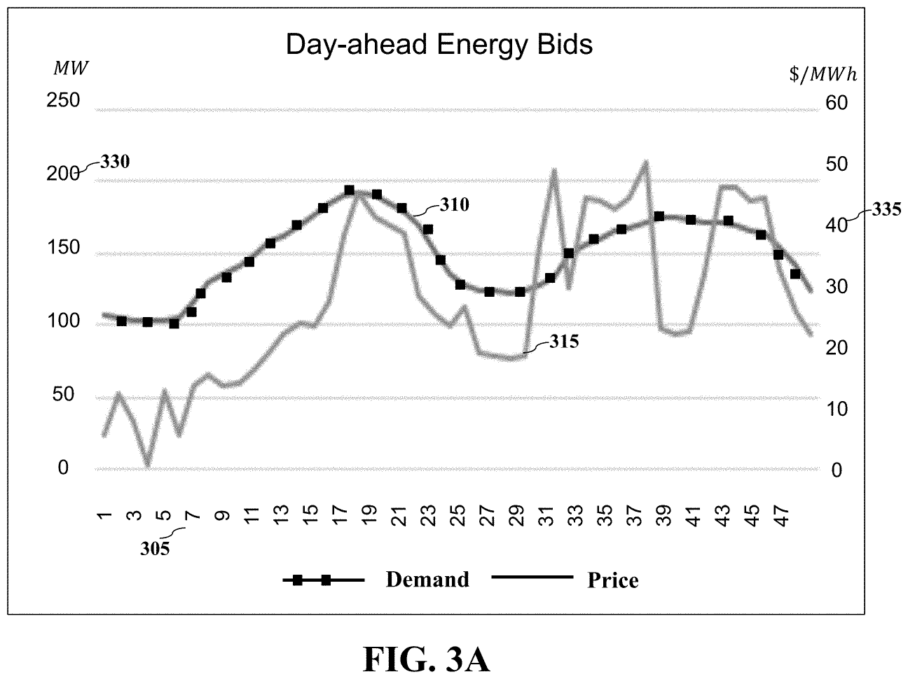

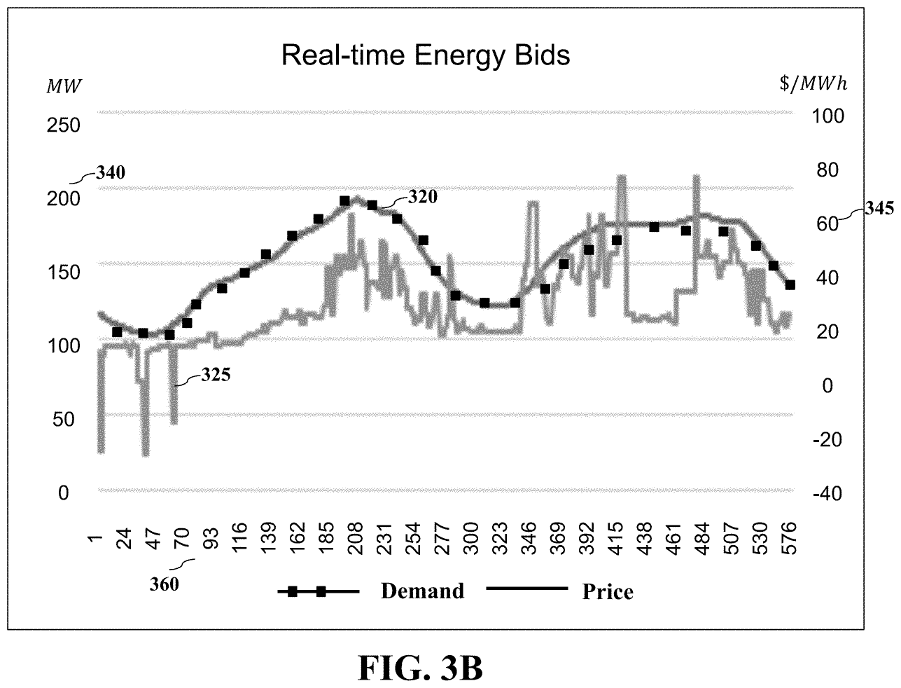

As noted above, the legitimate and illegitimate trading profiles may demonstrate different similarity between trading profiles with different time intervals, which can be demonstrated by FIGS. 3, 4 and 5.

FIG. 3A and FIG. 3B are graphs illustrating legitimate trades across two energy markets including the cleared day-ahead hourly bids (FIG. 3A) and real-time bids for each five (5) minutes (FIG. 3B) for two consecutive days of a single power-consuming trader, or a group of power consuming traders, according to some embodiments of the present disclosure. In FIG. 3A, the left and right vertical axes, 330 and 335, represent the bided amount of energy 310 and price 315 at the day-ahead market, respectively, and the horizontal axe 305 is the hourly time interval. Similarly, in FIG. 3B, the left and right vertical axes, 340 and 345, represent the bided amount of energy 320 and price 325 at the real-time market, respectively, and the horizontal axe 360 is the time interval with length of five minutes. Comparing 310 with 320, it is obvious that two curves can match each other closely.

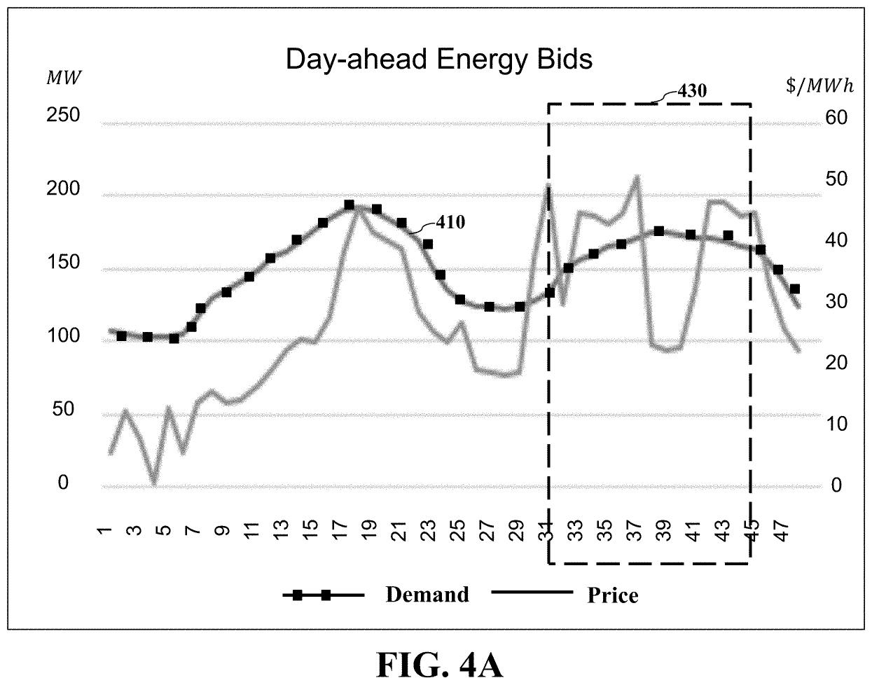

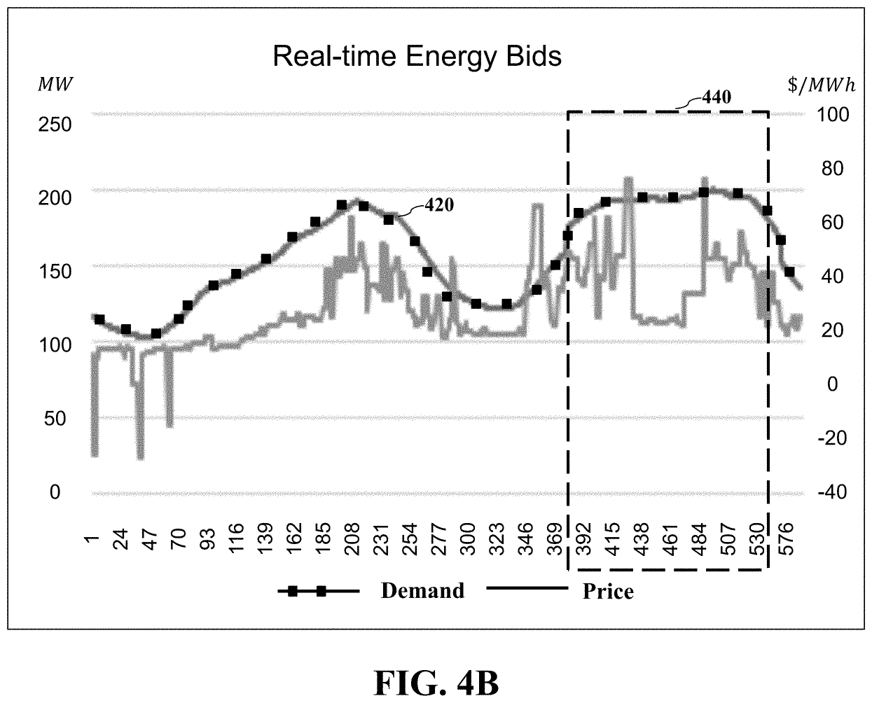

FIG. 4A and FIG. 4B are graphs illustrating possible illegitimate trades at peak hours including the cleared day-ahead hourly bids (FIG. 4A) and real-time bids for each five (5) minutes (FIG. 4B), according to illegitimate trading. Comparing the bided amount of energy 410 in FIG. 4A and 420 in FIG. 4B, there is a time window that two profiles have significant difference in bided amount of energy, i.e. 430 and 440 in FIG. 4A and FIG. 4B, respectively. This profile mismatches occurred at the moments for system peak hours, and might require the power system significant efforts to deal with such significant peak shortage, therefore this activity can be regarded as peak hours' market manipulation.

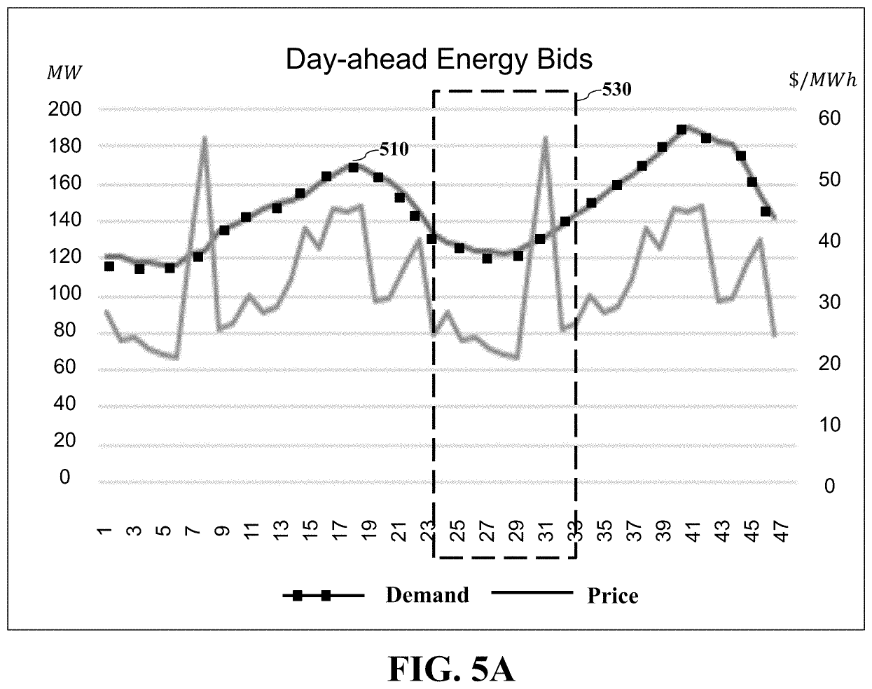

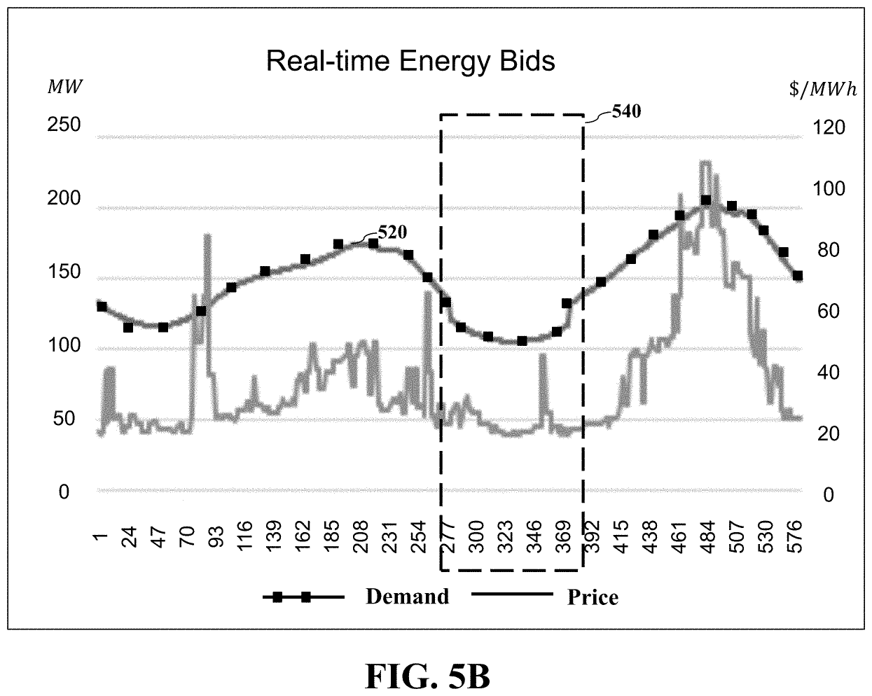

FIG. 5A and FIG. 5B are graphs illustrating possible illegitimate trades at valley hours including the cleared day-ahead hourly bids (FIG. 5A) and real-time bids for each five (5) minutes (FIG. 5B), according to some embodiments of the present disclosure. Similarly, there is a time window that two profiles have significant difference in bided amount of energy, i.e. 530 and 540 in FIG. 5A and FIG. 5B, by examining two profiles, 510 and 520, shown in FIG. 5A and FIG. 5B. This profile mismatches occurred at the moments for system valley hours. Due to significant valley excess, this activity will create extra burden for the system to lower the system minimal technical outputs, therefore it can be regarded as valley hours' market manipulation.

Characteristic Measures for Illegitimate Trades

We use eight different measures to characterize the features of illegitimate trades, including peak shortage attribute, valley excess attribute, capacity matching attribute, up-ramping shortage attribute, down-ramping shortage attribute, ramping matching attribute, cross-market correlation attribute, and environmental impact attribute. The first 7 features are determined based on the comparison of cleared day-ahead bid and executed real-time bids or real-time bids to be executed. For simplicity, the executed real-time bids or real-time bids to be executed are also called as actual real-time bids in this disclosure. The eighth feature is used to quantity the environmental impacts to the differences between cleared day-ahead bids and actual real-time bids.

It is noted that the formulas for trade feature calculation might be slight difference between ones for a power producer and for a power consumer. The powers used in the formulas refer to the purchased or purchasing amount of powers for a power consumer, and the sold or selling amount of powers for a power producer.

The formulas are given for any trader or trader group in the markets. The trader can be a single power producer, or a group of power producer such as virtual power plants (VPPs). The trader can also be a single power consumer, or a group of power consumers, such as load serving entities (LSEs).

Assumed that the day-ahead cleared energy bid for a day-ahead time interval h, and the actual real-time bid for a real-time interval m are Pₕ^{DA} and Pₘ^{RT}, respectively. Each day-ahead interval includes Nₛ real-time intervals, and each day-ahead cycle includes Nₕ day-ahead intervals in total. For example, if a time interval for a day-head market is 1 hour, and for a real-time market is 5 minutes, then each day-ahead interval including 12 real-time intervals, i.e. Nₛ=12. Each day-ahead bidding cycle includes 24 hours, i.e., Nₕ=24.

The average actual real-time bid, \hat{P}ₕ^{RT} for a given day-ahead time interval h can be determined as:

$${\hat{P}}_{h}^{R T} = \frac{1}{{N}_{s}} {\sum }_{m ∈ M ( h )} {P}_{m}^{R T} \qquad ( 1 )$$

M(h) is the set of real-time intervals m within the given day-ahead interval h.

The first characteristic measure is a peak shortage attribute, Aₕ^{peak-short} which is used to measure the power shortage of average actual real-time bid over cleared day-ahead bid during a peak period over a peak monitoring window. The peak monitoring window includes W^{peak} day-ahead intervals retrieved from the study day-ahead interval. For example, if W^{peak}=4, the monitoring window includes 3 previous day-ahead time intervals, besides the study time interval h. The peak shortage attribute is normalized with the maximum average real-time bid over past day-ahead intervals within the peak monitoring window.

The peak shortage attribute for a given day-ahead interval h, Aₕ^{peak-short} is defined as the ratio of the accumulated power deviation ΔP_{h-h′}^{peak} for all common day-ahead intervals between the peak period and a given monitoring period, over maximal average real-time bid within the given peak monitoring period:

$${A}_{h}^{\text{peak} \text{-} \text{short}} = \frac{{Σ}_{{h}^{′} = 0}^{{W}^{p e a k} - 1} [ 0.5 + 0.5 sgn ( {P}_{h - {h}^{′}}^{D A} - {α}^{p e a k} {\hat{P}}_{h}^{D A} ) ] max ( 0 , {Δ P}_{h - {h}^{′}}^{p e a k} )}{{max}_{{h}^{′} = \{ 0 , 1 , \text{. . . ,} {W}^{peak} - 1 \}} {\hat{P}}_{h - {h}^{′}}^{R T}} \qquad ( 2 )$$

wherein, ΔP_{h-h′}^{peak} is the power deviation defined as the difference between cleared day-ahead bid and average real-time bid for a power producer, or the difference between average real-time bid and cleared day-ahead bid for a power consumer according to:

$$Δ {P}_{h - {h}^{′}}^{p e a k} = \{ \begin{matrix}{P}_{h - {h}^{′}}^{D A} - {\hat{P}}_{h - {h}^{′}}^{R T} & for a power producer \\ {\hat{P}}_{h - {h}^{′}}^{R T} - {P}_{h - {h}^{′}}^{D A} & for a power consumer\end{matrix} \qquad ( 3 )$$

wherein, sgn(⋅) is a sign function, [0.5+0.5sgn(P_{h-h′}^{DA}−α^{peak}\hat{P}ₕ^{DA})] equals 1 and not 0 only when the time interval is within the peak period. The peak period for the study day-ahead interval h is defined as the set of day-ahead time intervals that the cleared day-ahead bid is greater than the average day-ahead bid, \hat{P}ₕ^{DA} within the past day-ahead cycle retrieved from the study interval times a peak scale factor α^{peak}, and \hat{P}ₕ^{DA} is defined as:

$${\hat{P}}_{h}^{D A} = \frac{1}{{N}_{h}} {\sum }_{{h}^{′} = 0}^{{N}_{h} - 1} {P}_{h - {h}^{′}}^{D A} \qquad ( 4 )$$

The peak scale factor is greater that 1.0. The given peak monitoring period is defined as the day-ahead intervals retrieved from the study interval within the given length of peak monitoring window.

One idea before the algorithm is that the illegitimate trade detection can be implemented proactively, or passively. For proactively implementation, the detection can be achieved real time, or near real time, that is the illegitimate trade can be identified immediately (at worst case only a few hours' delay, and the number of delayed hours is defined by the window for example W^{peak}). For passively implementation, the detection can only identify the legitimacy status for trades within past 24 hours by setting the monitoring windows as 24 hours.

The second characteristic measure is a valley excess attribute, Aₕ^{valley_excess} which is used to measure the difference between cleared day-ahead and average actual real-time bid during valley period over a valley monitoring window with length of W^{valley} day-ahead intervals. The valley excess attribute is normalized with the maximum average real-time bid over past valley monitoring window.

The valley excess attribute for a given day-ahead interval, Aₕ^{valley-excess} is defined as the ratio of the accumulated power deviations ΔP_{h-h′}^{valley} for all common day-ahead intervals between the valley period and a given valley monitoring period, over maximal average real-time bid within the given valley monitoring period:

$${A}_{h}^{\text{valley} \text{-} \text{excess}} = \frac{{Σ}_{{h}^{′} = 0}^{{W}^{valley} - 1} [ 0.5 + 0.5 sgn ( {\hat{P}}_{h}^{DA} / {α}^{valley} - {P}_{h - {h}^{′}}^{D A} ) ] max ( 0 , Δ {P}_{h - {h}^{′}}^{valley} )}{{max}_{{h}^{′} = \{ 0 , 1 , . . . , {W}^{valley} - 1 \}} {\hat{P}}_{h - {h}^{′}}^{R T}} \qquad ( 5 )$$

The given valley monitoring period is defined as the day-ahead intervals retrieved from the study interval within the given length of valley monitoring window. The power deviations ΔP_{h-h′}^{valley} are defined as the differences between average real-time bid and cleared day-ahead bid for a power producer, and as the differences between cleared day-ahead bid and average real-time bid for a power consumer, according to:

$$Δ {P}_{h - {h}^{′}}^{valley} = \{ \begin{matrix}{\hat{P}}_{h - {h}^{′}}^{R T} - {P}_{h - {h}^{′}}^{D A} & for a power producer \\ {P}_{h - {h}^{′}}^{D A} - {\hat{P}}_{h - {h}^{′}}^{R T} & for a power consumer\end{matrix} \qquad ( 6 )$$

The valley period for the study day-ahead interval h is defined as the set of day-ahead time intervals that the cleared day-ahead bid is less than the average day-ahead bid, \hat{P}ₕ^{DA} within the past day-ahead cycle retrieved from the study interval divided by a valley scale factor α^{valley}. The valley scale factor is greater that 1.0. [0.5+0.5sgn(\hat{P}ₕ^{DA}/α^{valley}−P_{h-h′}^{DA})] equals 1 and not 0 only when the time interval is within the valley period.

The third characteristic measure is a capacity matching attribute, Aₕ^{capacity_matching} which is used to measure the difference between cleared day-ahead and average actual real-time bid over past day-ahead cycle. The capacity matching attribute is normalized with the maximum average real-time bid over a period of day-ahead cycle.

The capacity matching attribute for a given day-ahead interval is defined as the ratio of the square root of averaged squared deviations between average real-time bid and cleared day-ahead bid for all day-ahead intervals of past day-ahead cycle over maximal average real-time bid within the past day-ahead cycle from the study interval.

$${A}_{h}^{c a p a c i t {y}_{-} m a t c h i n g} = \frac{\sqrt{\frac{1}{{N}_{h}} {{Σ}_{{h}^{′} = 0}^{{N}_{h} - 1} ( {\hat{P}}_{h - {h}^{′}}^{R T} - {P}_{h - {h}^{′}}^{D A} )}^{2}}}{{max}_{{h}^{′} = \{ 0 , 1 , … , {N}_{h} - 1 \}} {\hat{P}}_{h - {h}^{′}}^{R T}} \qquad ( 7 )$$

The fourth characteristic measure is an up-ramping shortage attribute, Aₕ^{upramp_short} which is an attribute measuring the difference between ramp-up rates for cleared day-ahead and average actual real-time bid during ramping up intervals over a monitoring window with length of W^{upramp} day-ahead intervals.

The up-ramping shortage attribute for a given day-ahead interval, Aₕ^{upramp_short} is defined as the ratio of the accumulated incremental power deviation, Δ²P_{h-h′}^{upramp} for all common day-ahead intervals between the up-ramping period and a given monitoring period, over maximal average real-time bid within the given monitoring period, and the given monitoring period is defined as the day-ahead intervals retrieved from the study interval within the given length of up-ramping monitoring window:

$${A}_{h}^{upramp \_ short} = \frac{\begin{matrix}{Σ}_{{h}^{′} = 0}^{{W}^{{upramp}_{- 1}}} [ 0.5 + 0.5 sgn ( {P}_{h - {h}^{′}}^{D A} - {P}_{h - {h}^{′} - 1}^{D A} ) ] \\ max ( 0 , {Δ}^{2} {P}_{h - {h}^{′}}^{upramp} )\end{matrix}}{{max}_{{h}^{′} = \{ 0 , 1 , … , {W}^{upramp} - 1 \}} {\hat{P}}_{h - {h}^{′}}^{R T}} \qquad ( 8 )$$

The incremental power deviation Δ²P_{h-h′}^{upramp} is defined as the difference between incremental power change of cleared day-ahead bid and incremental power change of average real-time bid for a power producer, and as ones the difference between incremental power change of average real-time bid and incremental power change of cleared day-ahead bid for a power consumer, as shown in (9):

$${Δ}^{2} {P}_{h - {h}^{′}}^{upramp} = \{ \begin{matrix}( {P}_{h - {h}^{′}}^{DA} - {P}_{h - {h}^{′} - 1}^{D A} ) - ( {\hat{P}}_{h - {h}^{′}}^{R T} + {\hat{P}}_{h - {h}^{′} - 1}^{R T} ) & for a power producer \\ ( {\hat{P}}_{h - {h}^{′}}^{R T} - {\hat{P}}_{h - {h}^{′} - 1}^{R T} ) - ( {P}_{h - {h}^{′}}^{D A} + {\hat{P}}_{h - {h}^{′} - 1}^{DA} ) & for a power consumer\end{matrix} \qquad ( 9 )$$

The up-ramping period for the study day-ahead interval h is defined as the set of day-ahead time intervals that the cleared day-ahead bid at a given day-ahead interval is greater than ones at previous day-ahead interval. [0.5+0.5sgn(P_{h-h′}^{DA}−P_{h-h′-1}^{DA})] equals 1 and not 0 only when the time interval is within the up-ramping period.

The fifth characteristic measure is a down-ramping shortage attribute, Aₕ^{dnramp_short} which is used to measure the difference between ramp-down rates for cleared day-ahead and average actual real-time bid during ramping down intervals over a monitoring window with length of W^{dnramp} day-ahead intervals.

The down-ramping shortage attribute for a given day-ahead interval, Aₕ^{dnramp_short} is defined as the ratio of the accumulated decremental power deviation, ∇²P_{h-h′}^{dnramp} for all common day-ahead intervals between the down-ramping period and a given monitoring period, over maximal average real-time bid within the given monitoring period, and the given monitoring period is defined as the day-ahead intervals retrieved from the study interval within the given length of down-ramping monitoring window:

$${A}_{h}^{dnramp \_ shor t} = \frac{\begin{matrix}{Σ}_{{h}^{′} = 0}^{{W}^{{dnramp}_{- 1}}} = [ 0.5 + 0.5 sgn ( {P}_{h - {h}^{′} - 1}^{D A} - {P}_{h - {h}^{′}}^{D A} ) ] \\ max ( 0 , {∇}^{2} {P}_{h - {h}^{′}}^{dnramp} )\end{matrix}}{{max}_{{h}^{′} = \{ 0 , 1 , … , {W}^{dnramp} - 1 \}} {\hat{P}}_{h - {h}^{′}}^{R T}} \qquad ( 10 )$$

The decremental power deviation ∇²P_{h-h′}^{dnramp} is defined as the difference between decremental power change of cleared day-ahead bid and decremental power change of average real-time bid for a power producer, and as ones the difference between decremental power change of average real-time bid and decremental power change of cleared day-ahead bid for a power consumer, as shown in (11):

$${∇}^{2} {P}_{h - {h}^{′}}^{dnrammp} = \{ \begin{matrix}( {P}_{h - {h}^{′} - 1}^{DA} - {P}_{h - {h}^{′}}^{D A} ) - ( {\hat{P}}_{h - {h}^{′} - 1}^{R T} - {\hat{P}}_{h - {h}^{′} - 1}^{R T} ) & for a power producer \\ ( {\hat{P}}_{h - {h}^{′} - 1}^{R T} - {\hat{P}}_{h - {h}^{′}}^{R T} ) - ( {P}_{h - {h}^{′} - 1}^{D A} - {\hat{P}}_{h - {h}^{′} - 1}^{DA} ) & for a power consumer\end{matrix} \qquad ( 11 )$$

The down-ramping period for the study day-ahead interval h is defined as the set of day-ahead time intervals that the cleared day-ahead bid at a given day-ahead interval is lower than ones at previous day-ahead interval. [0.5+0.5sgn(P_{h-h′-1}^{DA}−P_{h-h′}^{DA})] equals 1 and not 0 only when the time interval is within the down-ramping period.

The sixth characteristic measure is a ramping matching attribute, Aₕ^{ramp_matching} which is used to measure the difference between ramping rates of cleared day-ahead and average actual real-time bid over past day-ahead cycle. The ramping matching attribute is normalized with the maximum average actual real-time bid over a period of day-ahead cycle.

The ramping matching attribute for a given day-ahead interval is defined as the ratio of the square root of averaged squared incremental power deviations between average real-time bid and cleared day-ahead bid for all day-ahead intervals of past day-ahead cycle over maximal average real-time bid within the past day-ahead cycle from the study interval, according to:

$${A}_{h}^{r a m {p}_{-} m a t c h i n g} = \frac{\sqrt{\frac{1}{{N}_{h}} {{Σ}_{{h}^{′} = 0}^{{N}_{h} - 1} ( ( {\hat{P}}_{h - {h}^{′}}^{R T} - {\hat{P}}_{h - {h}^{′} - 1}^{R T} ) - ( {P}_{h - {h}^{′}}^{D A} - {P}_{h - {h}^{′} - 1}^{DA} ) )}^{2}}}{{max}_{{h}^{′} = \{ 0 , 1 , … , {N}_{h} - 1 \}} {\hat{P}}_{h - {h}^{′}}^{R T}} \qquad ( 12 )$$

The seventh characteristic measure is a cross-market correlation attribute. Aₕ^{correlation} which is used to measure the correlation between cleared day-ahead bid and average actual real-time bid over past day-ahead cycle, according to:

$${A}_{7}^{correlation} = \frac{( {N}_{h} {\sum }_{{h}^{′} = 0}^{{N}_{h} - 1} {\hat{P}}_{h - {h}^{′}}^{RT} {P}_{h - {h}^{′}}^{DA} - {\sum }_{{h}^{′} = 0}^{{N}_{h} - 1} {\hat{P}}_{h - {h}^{′}}^{RT} {\sum }_{{h}^{′} = 0}^{{N}_{h} - 1} {P}_{h - {h}^{′}}^{DA} )}{\sqrt{\begin{matrix}[ {N}_{h} {\sum }_{{h}^{′} = 0}^{{N}_{h} - 1} {( {\hat{P}}_{h - {h}^{′}}^{RT} )}^{2} - {( {\sum }_{{h}^{′} = 0}^{{N}_{h} - 1} {\hat{P}}_{h - {h}^{′}}^{RT} )}^{2} ] \\ [ {N}_{h} {\sum }_{{h}^{′} = 0}^{{N}_{h} - 1} {( {P}_{h - {h}^{′}}^{DA} )}^{2} - {( {\sum }_{{h}^{′} = 0}^{{N}_{h} - 1} {\hat{P}}_{h - {h}^{′}}^{DA} )}^{2} ]\end{matrix}}} \qquad ( 13 )$$

This attribute can also be defined and used for measuring the correlation of activities between different market players based on either cleared day-ahead or actual average real-time bid over past day-ahead cycle.

The eighth characteristic measure is an environmental impact attribute, Aₕ^{env-impact} which is used to measure the impacts of equipment forced and scheduled outages, severe weather, holiday and special events on the mismatches between the cleared day-ahead and actual average real-time bid over past day-ahead cycle.

For a power consumer, Aₕ^{env-impact} is determined based on the weather information, such as outdoor temperature and humidity:

$${A}_{h}^{env \text{-} i m p a c t} = {A}_{h}^{d t y p e} ( \begin{matrix}1.0 + {A}_{h}^{t o v e τ} [ 0.5 + 0.5 sgn ( {\hat{T}}_{h} - \overline{{T}_{h}} ) ] max ( 0 , {\hat{T}}_{h} - {T}_{h} ) + \\ {A}_{h}^{t u n d e τ} [ 0.5 + 0.5 sgn ( {\hat{T}}_{h} - {T}_{h} ) ] max ( 0 , {T}_{h} - {\hat{T}}_{h} )\end{matrix} ) \\ ( 1.0 + {A}_{h}^{h o v e τ} [ 0.5 + 0.5 sgn ( {\hat{H}}_{h} - \overline{{H}_{h}} ) ] max ( 0 , {\hat{H}}_{h} - {H}_{h} ) + {A}_{h}^{h u n d e τ} [ 0.5 + 0.5 sgn ( {\hat{H}}_{h} - {H}_{h} ) ] max ( 0 , {H}_{h} - {\overline{H}}_{h} ) ) \qquad ( 14 )$$

wherein Aₕ^{dtype} is the scale factor defined for holidays and special events, Aₕ^{tover} and Aₕ^{tunder} are the scale factors for energy bid changes caused by temperature mismatches between the average real time values and day-ahead forecasting values, Aₕ^{hover} and Aₕ^{hunder} are the coefficients for emerge bid changes caused by humidity mismatches between the average real time values and day-ahead forecasting values. Please be note that only the temperature/humidity is greater than an upper threshold or lesser than a lower threshold, the related temperature/humidity mismatch between real-time and day-ahead can contribute to the attribute Aₕ^{env-impact}. \hat{T}ₕ and Ĥₕ are the average real time temperature and humidity for the day-ahead interval h; Tₕ and Hₕ are the forecasted temperature and humidity for the day-ahead interval h; T̅ₕ and Tₕ, H̅ₕ̅ and Hₕ are the upper and lower thresholds for temperatures and humidity values.

For a power producer, Aₕ^{env-impact} is determined based on the fuel availability Aₕ^{fuel} and equipment availably Aₕ^{equip} as:

Aₕ^{env-impact}=Aₕ^{equip}Aₕ^{fuel} (15)

wherein Aₕ^{fuel} may be weather related, and Aₕ^{equip} depends on equipment scheduled outage and random faults.

The attribute Aₕ^{env-impact} can also be set by operator manually to include any impacts that not defined here.

Illegitimate Trade Sample Generation and Illegitimate Type Labeling

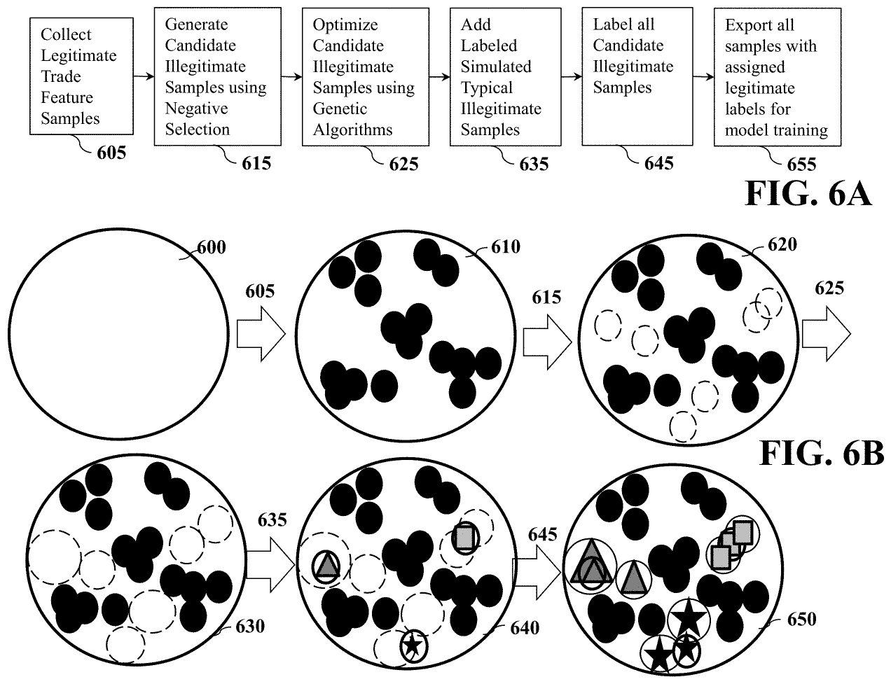

A genetic algorithms-based negative selection procedure is used to generate illegitimate trade feature samples, and then based on simulated typical illegitimate trade profiles to label each generated sample with a specific label of illegitimate trade type. The procedure is demonstrated in FIG. 6A and FIG. 6B.

FIG. 6A gives the steps to generate and label illegitimate samples based on legitimate samples and simulated typical illegitimate samples. The procedure first collects legitimate trade samples 605, then based on those samples, generates candidate illegitimate samples using negative selection 615. The generated candidate illegitimate samples are further optimized 625 to avoid overlapping with legitimate samples and maximize candidate sample coverage radius. After that, we create a set of simulated typical illegitimate samples 635, and each generated illegitimate sample is 645 assigned to a specific type based on its fitness to simulated typical illegitimate samples. At last, all samples with assigned legitimacy status labels are exported 655 for model training.

The samples of illegitimate trade features are further classified into different types, such as anomaly peak, anomaly valley and so on. This task can be achieved based on a set of pre-defined illegitimate trade profiles for different illegitimate trade types. The illegitimate trade feature sample is labelled with a type of illegitimate trade from multiple illegitimate trade types according to its fitness to typical anomaly trade feature samples determined based on pre-defined illegitimate trade profiles. The illegitimate trade feature sample is labelled with a type of illegitimate trade from multiple illegitimate trade types by checking if the study sample's features are within the pre-defined variation ranges of trade features for each illegitimate trade type.

FIG. 6B illustrates the evolving process for the sample set that used for supervised learning after implementing each step of FIG. 6A. The initial sample set is empty represented as a big hollow cycle 600. After step 605, the legitimate samples expressed as small solid circles are added into the sample set. After step 615, the illegitimate samples represented as small hollow dashed circles 620 are added into the sample set, and associated sizes and locations 630 are optimized through step 625. The simulated typical illegitimate samples 640 represented as circles embedded with solid triangles, rectangles and stars are added-in through step 635. After step 645, all generated illegitimate samples 650 are assigned a specific label according to the distance to simulated samples that expressed as circles embedded with triangles, recoinages or stars.

For sake of computation efficiency, each feature attribute Aₕ^{type}, Aₕ^{type}∈{Aₕ^{peak-short}, Aₕ^{valley_excess}, Aₕ^{capacity_matching}, Aₕ^{upramp_short}, Aₕ^{dnramp_short}, Aₕ^{ramp_matching}, Aₕ^{correlation}, Aₕ^{env-adj}} is first converted into a scaled integer value, [symbol] before applying of the genetic algorithms:

$$= int [ \frac{( {A}_{h}^{t y p e} - {A}_{h}^{type} ) {B}_{i}}{\overline{{A}_{h}^{t y p e}} - {A}_{h}^{t y p e}} ] \qquad ( 15 )$$

wherein A̅ₕ̅^̅{̅t̅y̅p̅e̅}̅ and Aₕ^{type} are the possible upper and lower thresholds of Aₕ^{type}. B^{type} is an integer bound number, for example, we can set B^{type}=2^{L}, L is the total of features, L=8.

The scaled integer [symbol] for the determined illegitimate samples will be re-converted into actual trade features, Aₕ^{type} before executing the labeling of illegitimate trade types and using for neural network training, according to:

$${A}_{h}^{t y p e} = {A}_{h}^{t y p e} + \frac{{B}^{t y p e}}{} ( {A}_{h}^{t y p e} - {A}_{h}^{t y p e} ) \qquad ( 16 )$$

In general, the genetic algorithms-based negative selection procedure for generating illegitimate trade feature samples can be described as follows:
Step 1: defining the representative legitimate samples based on historical trading profiles obtained from day-ahead and real-time markets. Suppose there are N legitimate samples available xᵢ^{C} (i=1, 2, . . . , N), with centers Oᵢ^{C}, and radiuses rᵢ^{C}. Oᵢ^{C} is defined by set of scaled integer trade features, Oᵢ^{C}=[Aᵢ₁^{C}, Aᵢ₂^{C}, . . . , A_{iL}^{C}]. If the number of available trade profiles is limited, we can directly use each trade profile to define one legitimate sample by setting its center using associated trade feature of the trade profile, and its radius using a pre-set threshold. If the number of available trade profiles is sufficient enough, we can use k-means clustering method to partition available trade profiles into N clusters and use trade features of each cluster to define one legitimate sample and set its center and radius based on the statistics of trade features of all trade profiles in the cluster.
Step 2: initializing a population of illegitimate samples using negative selection procedure. The candidate illegitimate samples are randomly generated, and compared with the legitimate sample set. Only those samples that do not match any element of the legitimate sample set are retained. Assumed there are M illegitimate samples xᵢ^{W} (i=1, 2, . . . , M) to be generated, with centers Oᵢ^{W}, and radiuses rᵢ^{W}, and the center Oᵢ^{W} is defined by set of scaled integer trade features, Oᵢ^{W}=[Aᵢ₁^{W}, Aᵢ₂^{W}, . . . , A_{iL}^{W}], and Aᵢⱼ^{W}(j=1, 2, . . . , L) is set randomly among 1 and the integer bound number for the j-th feature, B^{j}. The radius of illegitimate sample i, rᵢ^{W} is defined based on its Euclidean distance to nearest legitimate sample k, according to:

rᵢ^{W}=∥Oₖ^{C}−Oᵢ^{W}∥_{L}_{₂}−rₖ^{C}; (17)

wherein Oₖ^{C}, and rₖ^{C}, are the center and radius of its nearest legitimate sample k, i.e.

$${‖ {O}_{k}^{C} - {O}_{i}^{W} ‖}_{{L}_{2}} = {min}_{j ∈ [ 1 , 2 , … , N ]} {‖ {O}_{j}^{C} - {O}_{i}^{W} ‖}_{{L}_{2}} \qquad ( 18 )$$

wherein ∥Oₖ^{C}−Oᵢ^{W}∥_{L}_{₂} and ∥Oⱼ^{C}−Oᵢ^{W}∥_{L}_{₂} represent the Euclidean distances between Oₖ^{C}, and Oᵢ^{W} and Oⱼ^{C} and Oᵢ^{W}, respectively, as shown below:

∥Oₖ^{C}−Oᵢ^{W}∥_{L}_{₂}=\sqrt{Σₗ₌₁^{L}(Aₖₗ^{C}−Aᵢₗ^{W})²} (19)

∥Oⱼ^{C}−Oᵢ^{W}∥_{L}_{₂}=\sqrt{Σₗ₌₁^{L}(Aⱼₗ^{C}−Aᵢₗ^{W})²} (20)
If there exists legitimate sample j, such that ∥Oⱼ^{C}−Oᵢ^{W}∥_{L}_{₂}≤rⱼ^{C}, this illegitimate sample j becomes invalid, since it indeed overlaps with a legitimate sample j.
Step 3: creating new population of illegitimate samples using the genetic algorithms. We first apply the crossover operator on the current population to create new population, then apply mutation operator to the newly created population to add more stochastic variations. Mutation is used to introduce variations into the trade feature bit-strings through replacing random bits of the bit-strings with their complementary values. Crossover is used to merge two bit-strings to produce new sample containing certain subparts from two existing samples. Based on the determined centers for new population, we can determine corresponding radiuses for those new illegitimate samples by using (17), accordingly.
Step 4: Combining the illegitimate samples from both Step 2 and Step 3 together, and retain the ones with top fitness to keep the population size fixed in each generation. That is, only the most fitted illegitimate samples have the possibility of survival in the next generation. We define the fitness of each illegitimate sample candidate by using its radius rᵢ^{W}, as calculated in (17). That is to say, those illegitimate samples with larger valid radiuses have higher fitness for evolution in the Genetic Algorithms.
Step 5: Repeat Step 3 to Step 4 until a preset convergence criterion is met. For example, the criteria can be that the minimal radius of illegitimate samples should be not less than a preset threshold

Using above genetic algorithms-based negative selection procedure, illegitimate sample i generated in this way has the maximal possible radius rᵢ^{W} without any overlapping with all the N legitimate samples.

After a certain number of qualified illegitimate samples are generated by such genetic algorithm based negative selection procedure, a predetermined illegitimate trade labels can be assigned to each illegitimate sample, and then those samples can be used to detect the legitimacy status for the incoming trades. Illegitimate trade labels are defined as detailed illegitimate trade types for the given trade profiles, or sets of trade features, such as anomaly peak, anomaly valley and so on.

The procedure for labeling illegitimate trade type to illegitimate samples can be described as follows:
Step 1: Generate at least one typical trade profile for each pre-defined illegitimate trade type through simulating the specific trading scenario defined for the given illegitimate type.
Step 2: Determine corresponding trade features for each typical illegitimate trade profiles, and create a set of typical illegitimate samples with specified illegitimate trade type.
Step 3: Assign the illegitimate type of the nearest typical illegitimate sample to an illegitimate sample as its illegitimate type based on Chebyshev distance. Assumed there are T typical illegitimate samples available, xᵢ^{TW}(i=1, 2, . . . , T) with centers Oᵢ^{TW} that defined by set of trade features, Oᵢ^{TW}=[Aᵢ₁^{TW}, Aᵢ₂^{TW}, . . . , A_{iL}^{TW}]. The illegitimate sample xᵢ^{W} is assigned the illegitimate type of the nearest typical illegitimate sample xₖ^{TW} measured by Chebyshev distance, i.e.

$${‖ {O}_{k}^{T W} - {O}_{i}^{W} ‖}_{{L}_{∞}} = {min}_{j ∈ [ 1 , 2 , … , T ]} {‖ {O}_{j}^{T W} - {O}_{i}^{W} ‖}_{{L}_{∞}} \qquad ( 21 )$$

wherein ∥Oₖ^{TW}−Oᵢ^{W}∥_{L}_{_{∞}} and ∥Oⱼ^{TW}−Oᵢ^{W}∥_{L}_{_{∞}} represent the Chebyshev distances between Oₖ^{TW} and or and Oᵢ^{W} and Oⱼ^{TW}and Oᵢ^{W}, respectively, as shown below:

$$\begin{matrix}{‖ {O}_{k}^{T W} - {O}_{i}^{W} ‖}_{{L}_{∞}} = {max}_{i = 1 , … , L} \vert {A}_{jl}^{T W} - {A}_{i l}^{W} \vert & ( 22 ) \\ {‖ {O}_{j}^{T W} - {O}_{i}^{W} ‖}_{{L}_{∞}} = {max}_{i = 1 , … , L} \vert {A}_{jl}^{T W} - {A}_{i l}^{W} \vert & ( 23 )\end{matrix}$$

Across-Market Illegitimate Trade Detection

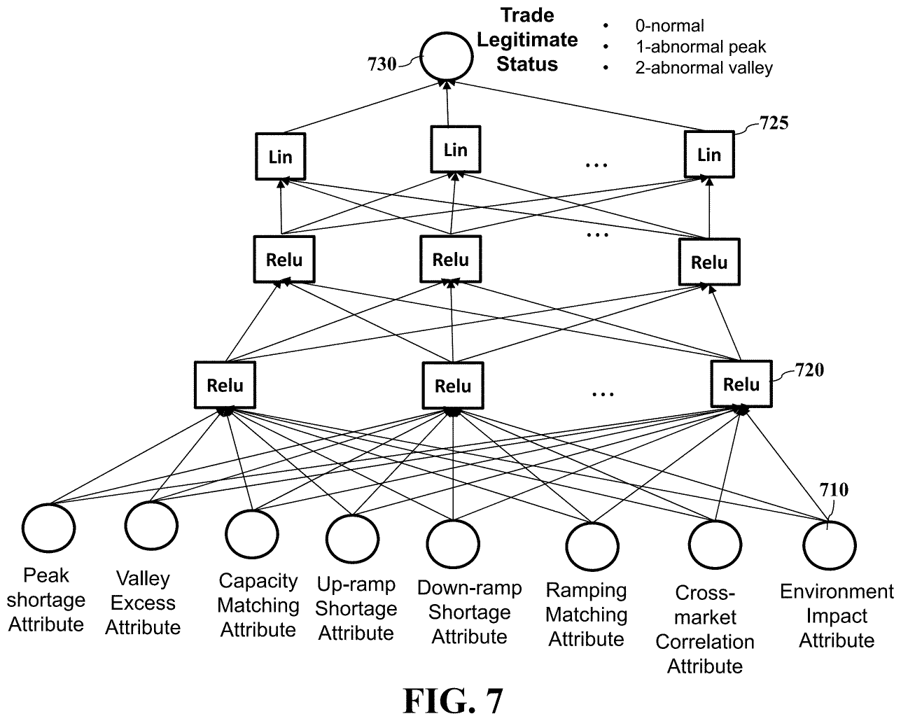

FIG. 7 is a schematic illustrating configuration of a feedforward neural networks (FNN) used for modeling illegitimate trade classification functions, according to some embodiments of the present disclosure. The FNN implicitly represent the relationship between the illegitimate trade types and the monitored trade feature attributes determined based on the cleared day-ahead bids and actual real-time bids. The FNN consists of one input layer, 710, L′ hidden layer, 720 and 725, and one output layer 730, and takes the illegitimate trade type as the output, and trade feature attributes as inputs.

The input layer consists 8 input units to receive the normalized values of eight different features for trading activities, including peak shortage attribute, valley excess attribute, capacity matching attribute, up-ramp shortage attribute, down-ramp shortage attribute, ramp matching attribute, cross-market correlation attribute, and environment impact attribute defined by weather conditions, equipment failure, holidays and special events.

The output layer consists 1 output unit to output the legitimacy status of trading activity, and the corresponding serial number for illegitimate trading type is used as the output value. For example, if we only consider abnormal peak, and abnormal valley trading as illegitimate, the possible output can be set as 0 for legitimate trade, 1 for abnormal peak trading, and 2 for abnormal valley trading.

The FNN may have multiple hidden layers, 720 and 725, and each layer may contain multiple hidden units. The hidden layer 1 720 takes an input vector xₜ^{[l]}, and computes a (hidden) output vector hₜ^{[l]} according to:

hₜ^{[l]}=relu(W^{[l]}xₜ^{[l]}+b^{[l]}) (24)

where relu(⋅) denotes a rectified linear unit function that is applied element-wise, W^{[l]} is a weight matrix, and b^{[l]} is a bias vector. Note that the output vector of one hidden layer is the input vector for the next hidden layer, i.e., x^{[l+1]}=h^{[l]}, except the last hidden layer 725, the output of which is mapped to the output through a linear unit as follows:

yₜ=Wh^{[L]}+b (25)

where W is a weight matrix, and b is a bias vector.

The multi-layer FNN is trained using back-propagation algorithm such that the mean squared error between the predicted output yₜ and the true value dₜ is minimized, i.e., by minimizing the following loss function, [symbol] ′:

$${ℓ}^{′} = \frac{1}{{m}^{tr}} {\sum }_{i = 1}^{{m}^{tr}} {( {y}_{t} - {d}_{r} )}^{2} \qquad ( 26 )$$

where, m^{tr} is the total number of samples for FNN training.

After trained using a set of training samples, the multi-layer FNN can be used to determine if a trading activity is legitimate when the associated trade feature attributes based on the cleared day-ahead bids and real-time bids are given.

Simple Example Experimentation

Below are numerical example using total 11 days' trade activities in an hourly day-ahead market and a five-minute real-time market. The training samples include total 312 hourly intervals, 9 days with legitimate trade, 2 days with abnormal peak, and 2 days with abnormal valley. The testing samples include total 96 hourly intervals, 2 days with legitimate trade, 1 days with abnormal peak, and 1 days with abnormal valley. The illegitimate trade profiles are modified from actual legitimate profiles according to illegitimate trade type definitions.

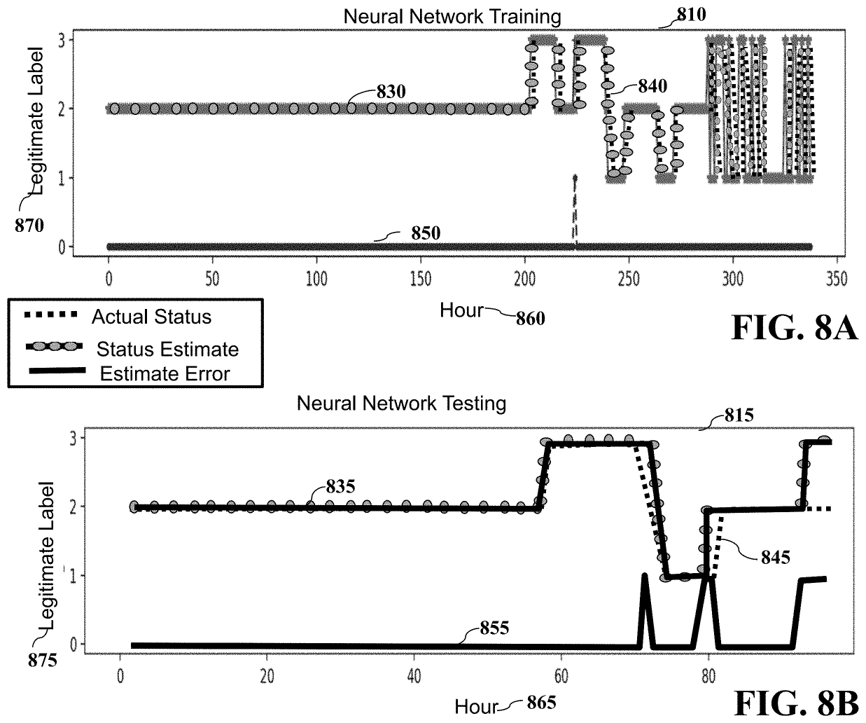

FIG. 8A and FIG. 8B are graphs illustrating the test results for using the trained neural network to estimate the legitimacy statuses of trading activities against the training samples and the testing samples.

FIG. 8A gives test results for training samples. FIG. 8A illustrates the accuracy statistics for estimate the legitimacy statuses 870 of training samples 810 at consecutive hours 860 using the trained neural network. Plots 830, 840 and 850 give the estimated value 830 and actual value 840 of legitimacy status 870 and corresponding estimation error 850 at given hourly interval 860 for each sample. As shown in FIG. 8A, the accuracy for training samples is 99.68%, only 1 hourly interval did not be not modeled correctly.

FIG. 8B illustrates the accuracy statistics for estimate the legitimacy statuses 875 of testing samples 815 at consecutive hours 865 using the trained neural network. Plots 835, 845 and 855 give the estimated value 835 and actual value 845 of legitimacy status 875 and corresponding estimation error 855 at given hourly interval 865 for each sample. As shown in FIG. 8B, the accuracy for testing samples is 91.67%, and there are 8 hourly intervals not estimated correctly. From this simple example, we can see that most of the legitimacy statuses for trading activities can be estimated correctly using the method disclosed in this disclosure.

Features

Some aspects of the present disclosure include that the system controls the amount of power generated by the one or more generators, or controls the amount of consumed power by the one or more power consumers, based on detecting anomaly trades by the given trader across electricity energy markets with different time intervals.

Another aspect of the present disclosure can include that the detecting of the anomaly trades by the given trader includes using the EC data associated with the given trader and the historical data associated with the given trader, such that the historical data includes past trade sets obtained from past cleared energy data and past bided energy data, over a number of respective past time increments, within a predetermined past period of time, wherein each past trade set includes a longer time interval and a corresponding set of shorter time intervals.

It is possible that an aspect can be that the longer time interval of the EC data is a cleared energy bid for a day-ahead bidding interval in a day-ahead energy market, and the shorter time interval of the EC data is a corresponding executed real-time bid associated with the cleared energy bid, such that the corresponding executed real-time bid is for a real-time bidding interval in a real-time energy market.

Another aspect can include that the longer time interval of the EC data is at a different time interval than the shorter time interval of the EC data.

Further, another aspect can be that the EC data includes environmental impact value data, that is associated with equipment failure, weather, holiday's, special events or other like data causing an effect to trading activities, and wherein the EC data is obtained after the historical data.

An aspect can include that the stored data includes stored executable functions, such that each executable function corresponds to a feature attribute of the set of feature attributes determining by comparing the trade data with longer time interval and the trade data with shorter time interval, wherein the set of feature attributes includes: (1) a peak shortage function used for determining the peak shortage value; (2) a valley excess function used for determining the valley excess value; (3) a capacity matching function used for determining the capacity matching value; (4) an up-ramping shortage function used for determining the up-ramping shortage value; (5) a down-ramping shortage function used for determining the down-ramping shortage value; (6) a ramping matching function used for determining the ramping matching value; and (7) a cross-market correlation function used for determining the cross-market correlation value.

Further still, wherein the peak shortage attribute is determined based on the accumulated power deviation between a cleared bid and an executed bid for all common intervals between a peak period and a given peak monitoring period; wherein the valley excess attribute is determined based on the accumulated power deviation between the cleared bid and the executed bid for all common intervals between a valley period and a given valley monitoring period; wherein the capacity matching attribute is determined based on a square root of averaged squared power deviations between the cleared bid and the executed bid for a past day-ahead cycle; wherein the up-ramping shortage attribute is defined based on the accumulated deviations of incremental power changes between the cleared bid and the executed bid for all common intervals between an up-ramping period and a given up-ramping monitoring period; wherein the down-ramping shortage attribute is defined based on the accumulated deviations of incremental power changes between the cleared bid and the executed bid for all common intervals between a down-ramping period and a given down-ramping monitoring period; wherein the ramping matching attribute is determined based on a square root of averaged squared incremental power deviations between the cleared bid and the executed bid for past day-ahead cycle; and wherein the cleared bid is cleared day-ahead bid, the executed bid is average actual real-time bid.

Another aspect can include that the trained anomaly trade module is a mathematical model relating the sets of feature attributes to a trade legitimate label, wherein the anomaly trade module is trained by a set of representative trade feature samples, wherein the trade legitimacy label is used to identify a true trade and a type of anomaly trade from multiple anomaly trades.

Another aspect can include that the anomaly trade module is represented using a multiple-layer feedforward neural network, wherein the feedforward neural network takes the sets of trade feature attributes as inputs, and the trade legitimacy labels as outputs.

Another aspect can include that the set of representative trade feature samples include true trade feature samples generated based on actual trade profiles from electricity markets, and labelled anomaly trade feature samples generated based on true trade feature samples.

A aspect can include that the anomaly trade feature samples are generated using a negative selection procedure and optimized using genetic algorithms based on true trade feature samples.

Another aspect can include that the negative selection is used to generate a first set of anomaly samples, wherein candidate anomaly samples are randomly generated, and compared with the true-trade sample set, such that only those samples that do not match any element of the true-trade sample set are retained.

Yet another aspect can include that the genetic algorithms is used to generate a second set of anomaly samples, wherein the crossover operation is applied on the first set of anomaly samples to generate the second set of anomaly samples, wherein the mutation operation is applied to the newly generated second set of anomaly samples to add more stochastic variations.

Yet still another aspect can include that all samples in the first and second sets of anomaly samples are ranked based on its Euclidean distance to the nearest true-trade sample, and only the top ranked anomaly samples are retained.

An aspect can include that the anomaly trade feature sample is labelled with a type of anomaly trade from multiple anomaly trades according to its Chebyshev distance to typical anomaly trade feature samples determined based on pre-defined typical anomaly trade profiles.

Another aspect can include that the detecting of each trade set as either the true trade or the type of anomaly trade from the multiple anomaly trades using the trained anomaly trade module by feeding the feature attributes of the trade set into the trained anomaly trade module as inputs and determining the trade legitimacy status based on the corresponding output of the trained anomaly trade module.

Yet another aspect can include that an output interface in communication with the computer outputs the control command to the controller, the controller receives the control command, wherein an operator associated with the controller implements the control command to adjust the power generation or consumption level of the determined producer or consumer through the generation control system of the producer or the energy management system of the consumer.

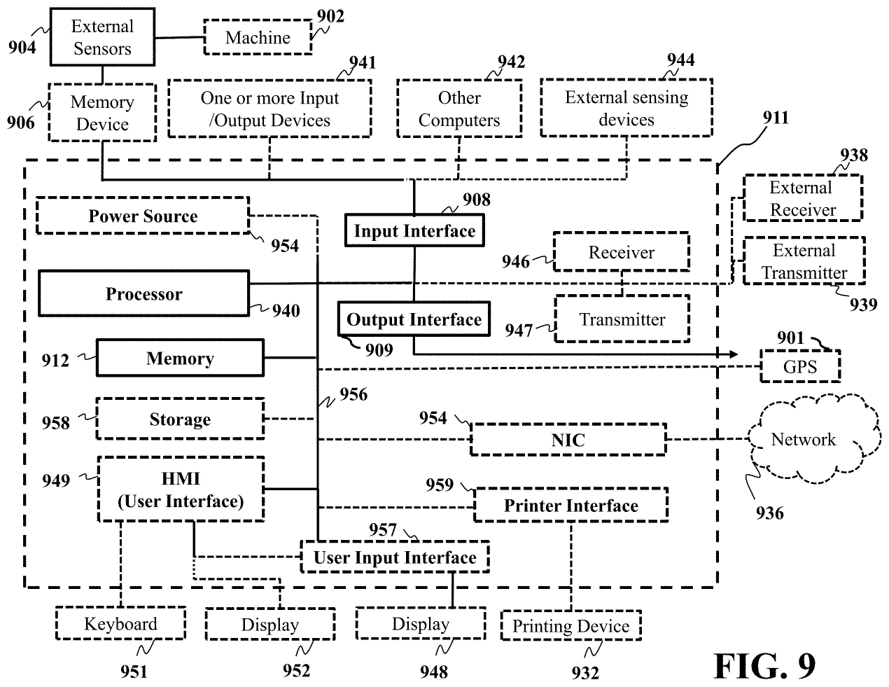

FIG. 9 is a block diagram of illustrating the method of FIG. 1B, that can be implemented using an alternate electricity market controller, according to embodiments of the present disclosure. The controller 911 includes a processor 940, computer readable memory 912, storage 958 and user interface 949 with display 952 and keyboard 951, which are connected through bus 956. For example, the user interface 949 in communication with the processor 940 and the computer readable memory 912, acquires and stores the data in the computer readable memory 912 upon receiving an input from a surface, keyboard surface, of the user interface 957 by a user.

Contemplated is that the memory 912 can store instructions that are executable by the processor, historical data, and any data to that can be utilized by the methods and systems of the present disclosure. The processor 940 can be a single core processor, a multi-core processor, a computing cluster, or any number of other configurations. The processor 940 can be connected through a bus 956 to one or more input and output devices. The memory 912 can include random access memory (RAM), read only memory (ROM), flash memory, or any other suitable memory systems.

Still referring to FIG. 9, a storage device 958 can be adapted to store supplementary data and/or software modules used by the processor. For example, the storage device 958 can store historical data and other related data as mentioned above regarding the present disclosure. Additionally, or alternatively, the storage device 958 can store historical data similar to data as mentioned above regarding the present disclosure. The storage device 958 can include a hard drive, an optical drive, a thumb-drive, an array of drives, or any combinations thereof.

The system can be linked through the bus 956 optionally to a display interface (not shown) adapted to connect the system to a display device (not shown), wherein the display device can include a computer monitor, camera, television, projector, or mobile device, among others.

The controller 911 can include a power source 954, depending upon the application the power source 954 may be optionally located outside of the controller 911. Linked through bus 956 can be a user input interface 957 adapted to connect to a display device 948, wherein the display device 948 can include a computer monitor, camera, television, projector, or mobile device, among others. A printer interface 959 can also be connected through bus 956 and adapted to connect to a printing device 932, wherein the printing device 932 can include a liquid inkjet printer, solid ink printer, large-scale commercial printer, thermal printer, UV printer, or dye-sublimation printer, among others. A network interface controller (NIC) 954 is adapted to connect through the bus 956 to a network 936, wherein data or other data, among other things, can be rendered on a third-party display device, third party imaging device, and/or third-party printing device outside of the controller 911. Further, the bus 956 can be connected to a Global Positioning System (GPS) device 901 or a similar related type device.

Still referring to FIG. 9, the data or other data, among other things, can be transmitted over a communication channel of the network 936, and/or stored within the storage system 958 for storage and/or further processing. Further, the data or other data may be received wirelessly or hard wired from a receiver 946 (or external receiver 938) or transmitted via a transmitter 947 (or external transmitter 939) wirelessly or hard wired, the receiver 946 and transmitter 947 are both connected through the bus 956. The controller 911 may be connected via an input interface 908 to external sensing devices 944 and external input/output devices 941. The controller 911 may be connected to other external computers 942, memory device 906, external sensors 904 and machine 902. An output interface 909 may be used to output the processed data from the processor 940.

### Embodiments

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Further, embodiments of the present disclosure and the functional operations described in this specification can be implemented in digital electronic circuitry, in tangibly-embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non-transitory program carrier for execution by, or to control the operation of, data processing apparatus. Further still, program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus” can encompass all kinds of apparatus, devices, and machines for processing data, including by way of example a programmable processor, a computer, or multiple processors or computers.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

What is claimed is:

1. A system for controlling an amount of power generated by one or more generators or controlling an amount of power consumed by one or more power consumers, for a period of time, comprising:
a computer including memory that stores data, the data includes trained modules, historical data, and computer-readable instructions that, when executed, cause the computer to perform the steps of:
receive data including electronically current (EC) data, the EC data includes trade sets for a given trader obtained from cleared energy data and bided energy data, over a number of respective time increments, within a predetermined period of time, wherein each trade set includes a longer time interval and a corresponding set of shorter time intervals;
determine a set of feature attributes for each trade set of the trade sets with the received current data, wherein the set of features attributes includes one or a combination of, a peak shortage value, a valley excess value, a capacity matching value, an up-ramping shortage value, a down-ramping shortage value, a ramping matching value, a cross-market correlation value, or an environmental impact value;
using a trained anomaly trade module with the determined sets of feature attributes, to detect each trade set as either a true trade or a type of anomaly trade from multiple anomaly trades, if the true trade is detected, then the detected true trade is stored in the memory;
generate a control command based on the detected type of anomaly trade from the multiple anomaly trades; and
output the control command to a controller associated with an operator, wherein the control command controls the amount of power generated by the one or more power producers or controls the amount of power consumed by the one or more power consumers, for a period of time, based upon the detected type of anomaly trade.

2. The system of claim 1, wherein the system controls the amount of power generated by the one or more generators, or controls the amount of power consumed by the one or more power consumers, based on detecting anomaly trades by the given trader across electricity energy markets with different time intervals.

3. The system of claim 2, wherein the detecting of the anomaly trades by the given trader includes using the EC data associated with the given trader and the historical data associated with the given trader, such that the historical data includes past trade sets obtained from past cleared energy data and past bided energy data, over a number of respective past time increments, within a predetermined past period of time, wherein each past trade set includes a longer time interval and a corresponding set of shorter time intervals.

4. The system of claim 1, wherein the longer time interval of the EC data is a cleared energy bid for a day-ahead bidding interval in a day-ahead energy market, and the shorter time interval of the EC data is a corresponding executed real-time bid associated with the cleared energy bid, such that the corresponding executed real-time bid is for a real-time bidding interval in a real-time energy market.

5. The system of claim 1, wherein the longer time interval of the EC data is at a different time interval than the shorter time interval of the EC data.

6. The system of claim 1, wherein the EC data includes environmental impact value data, that is associated with equipment failure, weather, holiday's, special events or other like data causing an effect to trading activities, and wherein the EC data is obtained after the historical data.

7. The system of claim 1, wherein the stored data includes stored executable functions, such that each executable function corresponds to a feature attribute of the set of feature attributes determining by comparing the trade data with longer time interval and the trade data with shorter time interval, wherein the set of feature attributes includes: (1) a peak shortage function used for determining the peak shortage value; (2) a valley excess function used for determining the valley excess value; (3) a capacity matching function used for determining the capacity matching value; (4) an up-ramping shortage function used for determining the up-ramping shortage value; (5) a down-ramping shortage function used for determining the down-ramping shortage value; (6) a ramping matching function used for determining the ramping matching value; and (7) a cross-market correlation function used for determining the cross-market correlation value.

8. The system of claim 7, wherein the peak shortage attribute is determined based on an accumulated power deviation between a cleared bid and an executed bid for all common intervals between a peak period and a given peak monitoring period; wherein the valley excess attribute is determined based on the accumulated power deviation between the cleared bid and the executed bid for all common intervals between a valley period and a given valley monitoring period; wherein the capacity matching attribute is determined based on a square root of averaged squared power deviations between the cleared bid and the executed bid for a past day-ahead cycle; wherein the up-ramping shortage attribute is defined based on an accumulated deviations of incremental power changes between the cleared bid and the executed bid for all common intervals between an up-ramping period and a given up-ramping monitoring period; wherein the down-ramping shortage attribute is defined based on the accumulated deviations of incremental power changes between the cleared bid and the executed bid for all common intervals between a down-ramping period and a given down-ramping monitoring period; wherein the ramping matching attribute is determined based on a square root of averaged squared incremental power deviations between the cleared bid and the executed bid for past day-ahead cycle; and wherein the cleared bid is cleared day-ahead bid, the executed bid is average executed real-time bid, or real-time bid to be executed.

9. The system of claim 1, wherein the trained anomaly trade module is a mathematical model relating the sets of feature attributes to a trade legitimate label, wherein the anomaly trade module is trained by a set of representative trade feature samples, wherein the trade legitimacy label is used to identify a true trade and a type of anomaly trade from multiple anomaly trades.

10. The system of claim 9, wherein the anomaly trade module is represented using a multiple-layer feedforward neural network, wherein the feedforward neural network takes the sets of trade feature attributes as inputs, and the trade legitimacy label as outputs.

11. The system of claim 9, the set of representative trade feature samples include true trade feature samples generated based on actual trade profiles from electricity markets, and labelled anomaly trade feature samples generated based on true trade feature samples.

12. The system of claim 11, the anomaly trade feature samples are generated using a negative selection procedure and optimized using a genetic algorithm based on true trade feature samples.

13. The system of claim 12, wherein the negative selection is used to generate a first set of anomaly samples, wherein candidate anomaly samples are randomly generated, and compared with the true trade feature sample set, such that only those samples that do not match any element of the true trade feature sample set are retained.

14. The system of claim 13, wherein the genetic algorithms is used to generate a second set of anomaly trade feature samples, wherein the crossover operation is applied on the first set of anomaly samples to generate the second set of anomaly samples, wherein the mutation operation is applied to the newly generated second set of anomaly samples to add more stochastic variations.

15. The system of claim 14, wherein all samples in the first and second sets of anomaly samples are ranked based on its Euclidean distance to the nearest true trade feature sample, and only the top ranked anomaly samples are retained.

16. The system of claim 11, the anomaly trade feature sample is labelled with a type of anomaly trade from multiple anomaly trades according to its Chebyshev distance to typical anomaly trade feature samples determined based on pre-defined typical anomaly trade profiles.

17. The system of claim 1, wherein the detecting of each trade set as either the true trade or the type of anomaly trade from the multiple anomaly trades using the trained anomaly trade module by feeding the feature attributes of the trade set into the trained anomaly trade module as inputs and determining the trade legitimacy label based on the corresponding output of the trained anomaly trade module.

18. The system of claim 1, wherein an output interface in communication with the computer outputs the control command to the controller, the controller receives the control command, wherein an operator associated with the controller implements the control command to adjust the power generation or consumption level of the determined producer or consumer through the generation control system of the producer or the energy management system of the consumer.

19. A method for controlling an amount of power generated by one or more generators or controlling an amount of power consumed by one or more power consumers, for a period of time, comprising:
receiving data including electronically current (EC) data, the EC data includes trade sets for a given trader obtained from cleared energy data and bided energy data, over a number of respective time increments, within a predetermined period of time, wherein each trade set includes a longer time interval and a corresponding set of shorter time intervals;
determining a set of feature attributes for each trade set of the trade sets with the received EC data, wherein the set of features attributes includes one or a combination of, a peak shortage value, a valley excess value, a capacity matching value, an up-ramping shortage value, a down-ramping shortage value, a ramping matching value, a correlation value by comparing the cleared day-ahead data and real-time purchase/sell bid data, or an environmental impact value;
using a trained anomaly trade module with the determined sets of feature attributes, to detect each trade set as either a true trade or a type of anomaly trade from multiple anomaly trades, if the true trade is detected, then the detected true trade is stored in a memory;
generating a control command based on the detected type of anomaly trade from the multiple anomaly trades; and
outputting the control command to a controller associated with an operator, wherein the control command controls the amount of power generated by the one or more power producers or controls the amount power consumed by the one or more power consumers, for a period of time, based upon the detected type of anomaly trade, wherein the steps of the method are implemented using a processor connected to the memory.

20. A non-transitory computer readable storage medium embodied thereon a program executable by a computer for performing a method, the method for controlling an amount of power generated by one or more generators or controlling an amount of consumed power by one or more power consumers, for a period of time, the method comprising:
receiving data including electronically current (EC) data, the EC data includes trade sets for a given trader obtained from cleared energy data and bided energy data, over a number of respective time increments, within a predetermined period of time, wherein each trade set includes a longer time interval and a corresponding set of shorter time intervals;
determining a set of feature attributes for each trade set of the trade sets with the received EC data, wherein the set of features attributes includes one or a combination of, a peak shortage value, a valley excess value, a capacity matching value, an up-ramping shortage value, a down-ramping shortage value, a ramping matching value, a correlation value by comparing the cleared day-ahead data and executed real-time data, or an environmental impact value;
using a trained anomaly trade module with the determined sets of feature attributes, to detect each trade set as either a true trade or a type of anomaly trade from multiple anomaly trades, if the true trade is detected, then the detected true trade is stored in a memory;
generating a control command based on the detected type of anomaly trade from the multiple anomaly trades; and
outputting the control command to a controller associated with an operator, wherein the control command controls the amount of power generated by the one or more power producers or controls the amount power consumed by the one or more power consumers, for a period of time, based upon the detected type of anomaly trade, wherein the steps of the method are implemented using a processor connected to the memory.
